(19) United States
(12) Patent Application Publication
(10) Pub. No.: US 2012/0290834 A1
(43) Pub. Date: Nov. 15, 2012

(54) KEY DISTRIBUTION DEVICE, TERMINAL DEVICE, AND CONTENT DISTRIBUTION SYSTEM

(76) Inventors: Takahiro YAMAGUCHI, Osaka (JP); Toshihisa Nakano, Osaka (JP); Motoji Ohmori, Osaka (JP); Kaoru Murase, Nara (JP)

(21) Appl. No.: 13/467,374

(22) Filed: May 9, 2012

Related U.S. Application Data
(60) Provisional application No. 61/484,859, filed on May 11, 2011.

(51) Int. Cl. H04L 9/08; H04L 29/06

(52) U.S. Cl. 713/156; 380/278

(57) ABSTRACT

A terminal device used in a content distribution system including a key distribution device, the terminal device, and a recording medium device, the key distribution device distributing a title key for protecting a content to the recording medium device, the terminal device for controlling writing of the title key on the recording medium device, and the recording medium device recording the content, wherein the key distribution device and the recording medium device comprise a communication unit configured to transfer the title key safely between the key distribution device and the recording medium device without direct involvement by the terminal device, and the terminal device confirms a supported function of the key distribution device and determines whether to permit operations pertaining to the key distribution device in accordance with the supported function.

This application claims benefit to the provisional U.S. Application 61/484,859, filed on May 11, 2011.

### TECHNICAL FIELD

The present invention relates to terminal devices that receive digitally distributed digital contents and write the digital contents to a recording medium.

### BACKGROUND ART

In order to protect the rights of the copyright owner of digital content, i.e. a digital work such as a movie or music, Blu-ray Discs™ use the Advanced Access Content System (AACS), a type of copyright protection technology. AACS provides developers of playback devices and creators of digital contents with technical specifications on copyright protection while stipulating the rules for copyright protection by establishing contracts. In this way, AACS offers a total copyright protection system encompassing everything from creation through playback by managing the implementation of security for both manufacturers that develop and sell playback devices and playback software as well as for copyright owners that develop and sell discs. A key issuing device under the AACS issues a device key for a playback device and issues a Media Key Block (MKB) for a content creation device. The content creation device uses the MKB to protect the content and records the MKB on the BD-ROM disc. In order to play back a content, a playback device reads the MKB and the content protected with the MKB and decrypts the protected content using the device key stored by the playback device.

As terminals become more compact, light-weight, and sophisticated, and as broadband networks become more widespread and offer improved transmission speed, digital content distribution services are also becoming popular. These services digitally distribute digital content via a network to a recording device (for example, a KIOSK terminal, a personal computer, etc.), which is used to record the digital content on a recording medium. A playback device (for example, a music player, a portable video display terminal, or the like) then plays back the content recorded on the recording medium. In the area of copyright protection technology for such digital content distribution services, efforts are being made to adopt technology for encrypted protection like the AACS adopted for Blu-ray Discs™.

### CITATION LIST

### Non-Patent Literature

[Non-Patent Literature 1] Advanced Access Content System (AACS) Prepared Video Book Revision 0.95

### SUMMARY OF INVENTION

### Technical Problem

Since the device key stored by a playback device can decrypt the MKB and the content protected by the MKB, malicious vendors analyze a playback device with a weakly implemented software player or the like in order to acquire the device key without authorization. Such vendors then use the dishonestly acquired device key to develop and sell an unauthorized tool that copies content.

In the realm of digital content distribution, content is recorded on a recording medium over a network. Therefore, release of data such as keys necessary for playback acquired from a weak recording device poses the problem of infringement on the rights of the content's copyright owner, as with Blu-ray Discs™.

For example, a device key may be maliciously acquired from a weak software recorder and used to allow an unauthorized tool to pose as a legitimate terminal device and attempt to acquire a title key directly from a key distribution device. Furthermore, an unauthorized tool may make unauthorized copies by maliciously using the device key of a weak software recorder to pose as a legitimate terminal device, read key information, such as the title key, from a recording medium device and write back the information with proper protection on another legitimate recording medium device, so that a legitimate terminal device can play back the other recording medium device.

### Solution to Problem

In order to solve the above problem, a terminal device according to an aspect of the present invention is used in a content distribution system including a key distribution device, the terminal device, and a recording medium device, the key distribution device distributing a title key for protecting a content to the recording medium device, the terminal device for controlling writing of the title key on the recording medium device, and the recording medium device recording the content, wherein the key distribution device and the recording medium device comprise a communication unit configured to transfer the title key safely between the key distribution device and the recording medium device without direct involvement by the terminal device, and the terminal device confirms a supported function of the key distribution device and determines whether to permit operations pertaining to the key distribution device in accordance with the supported function.

### Advantageous Effects of Invention

The terminal device of the present invention can determine the supported function of the key distribution device. Therefore, even if an unauthorized key distribution device is provided with a pair of a key distribution device private key, acquired maliciously from a key distribution device, and a certificate including a public key, the terminal device can determine the supported function of the key distribution device and execute only limited functions, thereby limiting the scope of damage suffered by copyright owners and content buyers.

### BRIEF DESCRIPTION OF DRAWINGS

FIG. 1 is an overall diagram of a content creation device, a key issuing device, a content distribution device, a key distribution device, a terminal device, and a recording medium device according to Embodiment 1 of the present invention.

FIG. 2 shows the configuration of the content creation device according to Embodiment 1 of the present invention.

FIG. 3 is a flowchart of operations by the content creation device according to Embodiment 1 of the present invention.

FIG. 4 shows the configuration of the key issuing device according to Embodiment 1 of the present invention.

FIG. 5A through 5D show the configuration of data used by the key issuing device according to Embodiment 1 of the present invention.

FIG. 6 is a flowchart of operations by the key issuing device according to Embodiment 1 of the present invention.

FIG. 7 shows the configuration of the content distribution device according to Embodiment 1 of the present invention.

FIG. 8 shows the configuration of data used by the content distribution device according to Embodiment 1 of the present invention.

FIG. 9 is a flowchart of operations by the content distribution device according to Embodiment 1 of the present invention.

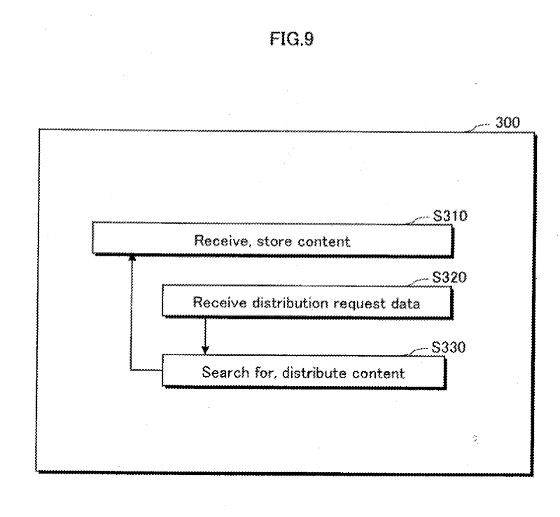

FIG. 10 shows the configuration of the key distribution device according to Embodiment 1 of the present invention.

FIG. 11 is a diagram of mutual authentication according to Embodiment 1 of the present invention.

FIG. 12 is a flowchart of operations by the key distribution device according to Embodiment 1 of the present invention.

FIGS. 13A and 13B show the configuration of data used by the terminal device according to Embodiment 1 of the present invention.

FIG. 14 shows the structure related to writing by the terminal device according to Embodiment 1 of the present invention.

FIG. 15 shows the structure related to playback by the terminal device according to Embodiment 1 of the present invention.

FIG. 16 is a flowchart of operations by the terminal device according to Embodiment 1 of the present invention.

FIGS. 17A and 17B show the configuration of data used by the key distribution device according to Embodiment 1 of the present invention.

FIG. 18 shows the configuration of the recording medium device according to Embodiment 1 of the present invention.

FIG. 19 is a flowchart of operations by the recording medium device according to Embodiment 1 of the present invention.

FIG. 20 is an overall diagram of a content distribution device, a key issuing device, a terminal device, and a recording medium device according to Embodiment 2 of the present invention.

FIG. 21 shows the configuration of the key issuing device according to Embodiment 2 of the present invention.

FIG. 22 is a flowchart of operations by the key distribution device according to Embodiment 2 of the present invention.

FIGS. 23A and 23B show the configuration of data used by the terminal device according to Embodiment 2 of the present invention.

FIG. 24 shows the structure related to transfer by the terminal device according to Embodiment 2 of the present invention.

FIG. 25 shows the structure related to restoration by the terminal device according to Embodiment 2 of the present invention.

FIG. 26 is a flowchart of transfer operations by the terminal device according to Embodiment 2 of the present invention.

FIGS. 27A and 27B show the configuration of data used by the key distribution device according to Embodiment 2 of the present invention.

FIG. 28 is a flowchart of restoration operations by the terminal device according to Embodiment 2 of the present invention.

FIGS. 29A and 29B show the configuration of data used by the key distribution device according to Embodiment 2 of the present invention.

FIG. 30 is an overall diagram of a content creation device, a content distribution medium device, a key issuing device, a terminal device, and a recording medium device according to Embodiment 3 of the present invention.

FIG. 31 shows the configuration of the content creation device according to Embodiment 3 of the present invention.

FIG. 32 is a flowchart of operations by the content creation device according to Embodiment 3 of the present invention.

FIG. 33 shows the configuration of the key distribution device according to Embodiment 3 of the present invention.

FIG. 34 is a flowchart of operations by the key distribution device according to Embodiment 3 of the present invention.

FIGS. 35A and 35B show the configuration of data used by the terminal device according to Embodiment 3 of the present invention.

FIG. 36 shows the structure of the terminal device according to Embodiment 3 of the present invention.

FIG. 37 is a flowchart of operations by the terminal device according to Embodiment 3 of the present invention.

FIGS. 38A and 38B show the configuration of data used by the key distribution device according to Embodiment 3 of the present invention.

FIG. 39 shows the configuration of the recording medium device according to Embodiment 3 of the present invention.

FIG. 40 is a flowchart of operations by the recording medium device according to Embodiment 3 of the present invention.

FIG. 41 shows the configuration of the content distribution medium device according to Embodiment 3 of the present invention.

FIG. 42 shows the configuration of a package that includes the content distribution medium device according to Embodiment 3 of the present invention.

FIG. 43 shows the configuration of the content distribution medium device according to Embodiment 3 of the present invention.

### DESCRIPTION OF EMBODIMENTS

The following describes embodiments of the present invention with reference to the figures.

### Embodiment 1

### Overall Configuration

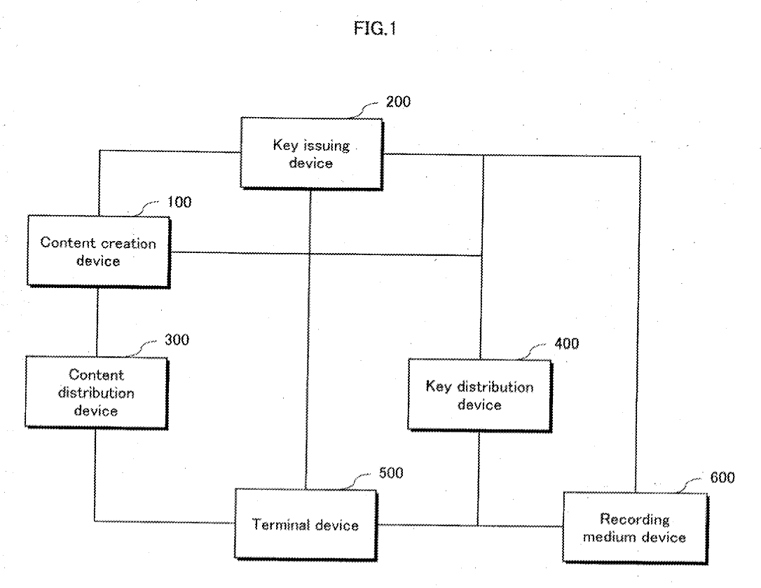

FIG. 1 shows the overall configuration of a content distribution system according to Embodiment 1 of the present invention. The content distribution system includes a content creation device 100, a key issuing device 200, a content distribution device 300, a key distribution device 400, a terminal device 500, and a recording medium device 600.

### Detailed Configuration of Content Creation Device 100

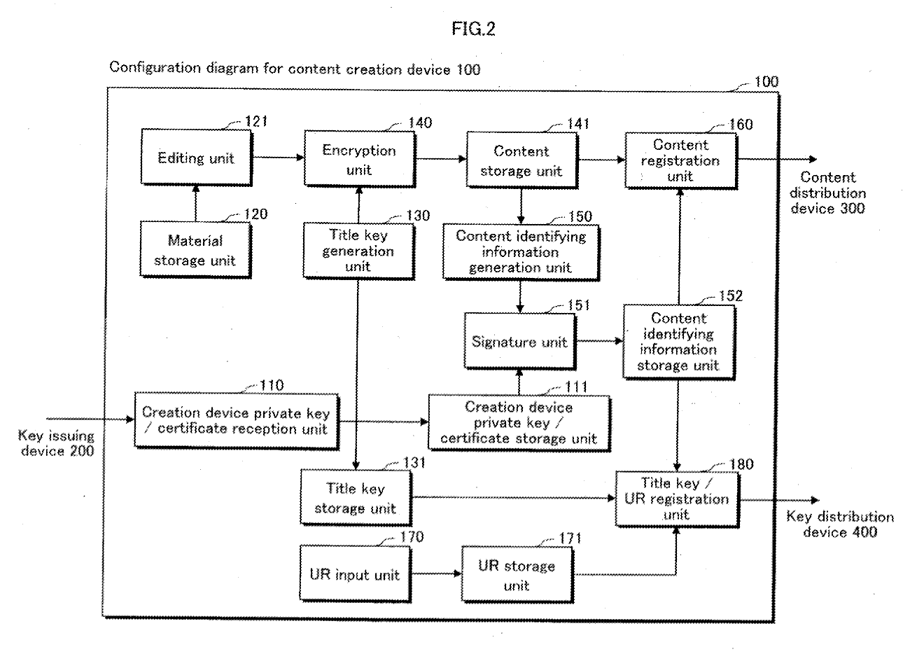

FIG. 2 shows the detailed configuration of the content creation device 100.

As shown in FIG. 2, the content creation device 100 includes a creation device private key/certificate reception unit 110, a creation device private key/certificate storage unit 111, a material storage unit 120, an editing unit 121, a title key generation unit 130, a title key storage unit 131, an encryption unit 140, a content storage unit 141, a content identifying information generation unit 150, a signature unit 151, a content identifying information storage unit 152, a content registration unit 160, a UR input unit 170, a UR storage unit 171, and a title key/UR registration unit 180.

The creation device private key/certificate reception unit 110 receives a key pair of a content creation device private key/content creation device certificate from the key issuing device 200.

The creation device private key/certificate storage unit 111 stores the key pair of the content creation device private key/content creation device certificate received by the creation device private key/certificate reception unit 110.

The material storage unit 120 stores material such as video and audio for a movie or the like. Creation of the actual video and audio is not related to the present invention and an explanation thereof is thus omitted from this description.

The editing unit 121 edits the material stored by the material storage unit 120.

The title key generation unit 130 generates a title key. The title key is, for example, a 128-bit random number.

The title key storage unit 131 stores the title key generated by the title key generation unit 130.

The encryption unit 140 encrypts the material edited by the editing unit 121 using the title key stored by the title key storage unit in order to generate content. Unless otherwise noted, “content” hereinafter refers to content that has been encrypted.

The content storage unit 141 stores the content encrypted by the encryption unit 140.

The content identifying information generation unit 150 generates content identifying information from the content stored by the content storage unit 141. For example, the content identifying information generation unit 150 divides the content into sections, calculates a hash value for each section, and lists the hash values in a hash table. The content identifying information generation unit 150 may then calculate a hash value for the hash table and use this hash value as the content identifying information for identifying the content.

Furthermore, the content identifying information generation unit 150 may transmit the hash table to the key issuing device 200. The key issuing device 200 may then assign a unique value to the hash table, append the unique value to the hash table, and provide the entire data with a signature to generate data with a countermeasure against tampering. The key issuing device 200 may then return the data to the content creation device 100. The content identifying information generation unit 150 may use the unique value assigned by the key issuing device 200 as the content identifying information.

The signature unit 151 may sign the content identifying information generated by the content identifying information generation unit 150 using the content creation device private key stored by the creation device private key/certificate storage unit 111 in order to protect the content identifying information from tampering. Note that as exemplified by the description of the content identifying information generation unit 150, when the key issuing device 200 attaches a signature, the signature provided by the signature unit 151 becomes redundant and may therefore be omitted.

The content identifying information storage unit 152 stores the content identifying information generated by the signature unit 151 and the content identifying information generation unit 150.

As the content, the content registration unit 160 registers, in the content distribution device 300, the content stored by the content storage unit 141 and the hash table and the like generated by the content identifying information generation unit 150. The hash table may be omitted.

The UR input unit 170 accepts input of a Usage Rule (hereinafter referred to as a UR) representing conditions for playback or transfer of content recorded on a recording medium device.

The UR storage unit 171 stores the UR inputted into the UR input unit 170.

The title key/UR registration unit 180 registers, in the key distribution device 400, the title key stored by the title key storage unit 131 and the UR stored by the UR storage unit 171.

### Creation Flow of Content Creation Device 100

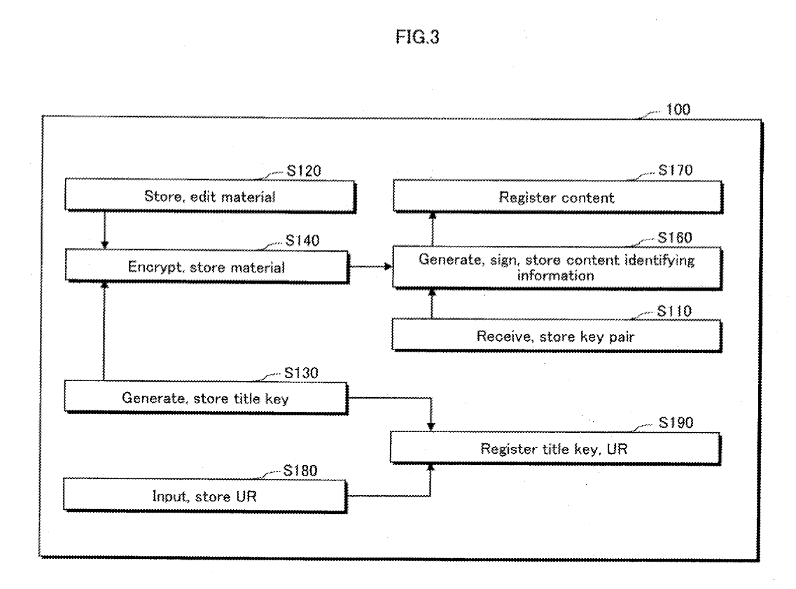

FIG. 3 shows the creation flow of the content creation device 100.

The creation device private key/certificate reception unit 110 receives the key pair of the content creation device private key/content creation device certificate from the key issuing device 200 and stores the key pair of the content creation device private key/content creation device certificate in the creation device private key/certificate storage unit 111 (S110).

The editing unit 121 edits the material stored by the material storage unit 120 (S120).

The title key generation unit 130 generates a title key and stores the title key in the title key storage unit 131 (S130).

The encryption unit 140 encrypts the material edited by the editing unit 121 with the title key stored by the title key storage unit 131 and stores the result in the content storage unit 141 (S140).

The content identifying information generation unit 150 reads the content stored by the content storage unit 141 and generates content identifying information that is unique to the content. For example, the content identifying information generation unit 150 may divide the content into blocks, calculate a hash value for each block, list the hast values in a hash table, calculate a hash value for the hash table, and use the hash value as the content identifying information. Alternatively, another method may be used. Additionally, the signature unit 151 attaches a signature to the content identifying information generated by the content identifying information generation unit 150 and stores the result in the content identifying information storage unit 152 (S160).

The content registration unit 160 registers the content stored in the content storage unit 141 in the content distribution device 300 (S170).

A person such as a user of the content creation device 100 uses the UR input unit 170 to input a UR, which represents rules related to playback and transfer of a content. The UR storage unit 171 stores the UR (S180).

The title key/UR registration unit 180 registers a combination of the title key stored by the title key storage unit 131 and the UR stored by the UR storage unit 171 in the key distribution device 400 (S190).

### Detailed Configuration of Key Issuing Device 200

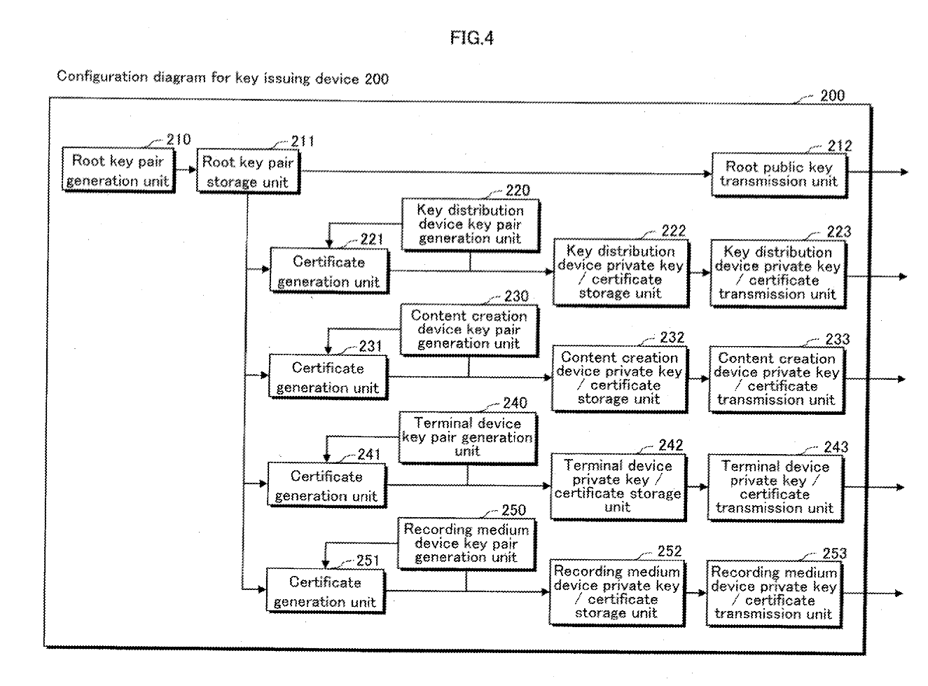

FIG. 4 shows the detailed configuration of the key issuing device 200.

As shown in FIG. 4, the key issuing device 200 includes a creation device root key pair generation unit 210, a root key pair storage unit 211, a root public key transmission unit 212, a key distribution device key pair generation unit 220, a certificate generation unit 221, a key distribution device private key/certificate storage unit 222, a key distribution device private key/certificate transmission unit 223, a content creation device key pair generation unit 230, a certificate generation unit 231, a content creation device private key/certificate storage unit 232, a content creation device private key/certificate transmission unit 233, a terminal device key pair generation unit 240, a certificate generation unit 241, a terminal device private key/certificate storage unit 242, a terminal device private key/certificate transmission unit 243, a recording medium device key pair generation unit 250, a certificate generation unit 251, a recording medium device private key/certificate storage unit 252, and a recording medium device private key/certificate transmission unit 253.

The root key pair generation unit 210 generates a key pair of a root public key and a root private key for the key issuing device 200, which is the security core in the management system of the present invention.

The root key pair storage unit 211 stores the key pair of root public key and the root private key generated by the root key pair generation unit 210.

The root public key transmission unit 212 transmits the root public key stored by the root key pair storage unit 211 to the key distribution device 400, the terminal device 500, and the recording medium device 600.

The key distribution device key pair generation unit 220 generates a key distribution device key pair composed of a key distribution device public key and a key distribution device private key to be embedded in the key distribution device 400.

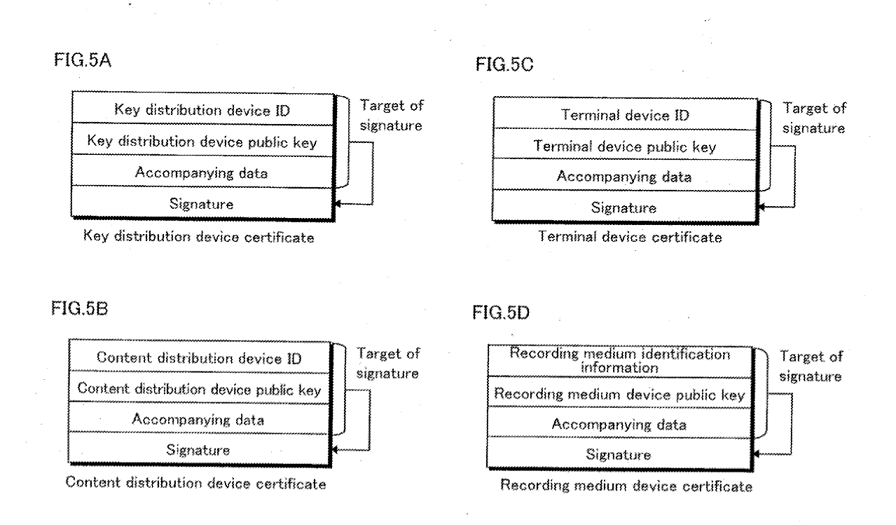

The certificate generation unit 221 generates a key distribution device certificate by using the root private key stored in the root key pair storage unit 211 to attach a signature to the key distribution device public key generated by the key distribution device key pair generation unit 220. FIG. 5A shows an example of the key distribution device certificate. The key distribution device certificate (FIG. 5A) is composed of a key distribution device ID, a key distribution device public key, accompanying data, and a signature.

The key distribution device private key/certificate storage unit 222 stores, as a pair, the key distribution device private key generated by the key distribution device key pair generation unit 220 and the key distribution device certificate generated by the certificate generation unit 221.

The key distribution device private key/certificate transmission unit 223 transmits the pair of the key distribution device private key and the key distribution device certificate stored by the key distribution device private key/certificate storage unit 222 to the key distribution device 400.

The content creation device key pair generation unit 230 generates a content creation device key pair composed of a content creation device public key and a terminal device private key to be embedded in the terminal device 500.

The certificate generation unit 231 generates a content creation device certificate by using the root private key stored by the root key pair storage unit 211 to attach a signature to the content creation device public key generated by the content creation device key pair generation unit 230. FIG. 5B shows an example of the content creation device certificate. The content creation device certificate in FIG. 5B is composed of a content creation device ID, a content creation device public key, accompanying data, and a signature.

The content creation device private key/certificate storage unit 232 stores, as a pair, the content creation device private key generated by the content creation device key pair generation unit 230 and the content creation device certificate generated by the certificate generation unit 231.

The content creation device private key/certificate transmission unit 233 transmits the pair of the content creation device private key and the content creation device certificate stored by the content creation device private key/certificate storage unit 232 to the content creation device 100.

The terminal device key pair generation unit 240 generates a terminal device key pair composed of a terminal device public key and a terminal device private key to be embedded in the terminal device 500.

The certificate generation unit 241 generates a terminal device certificate by using the root private key stored by the root key pair storage unit 211 to attach a signature to the terminal device public key generated by the terminal device key pair generation unit 240. FIG. 5C shows an example of the terminal device certificate. The terminal device certificate (FIG. 5C) is composed of a terminal device ID, a terminal device public key, accompanying data, and a signature.

The terminal device private key/certificate storage unit 242 stores, as a pair, the terminal device private key generated by the terminal device key pair generation unit 240 and the terminal device certificate generated by the certificate generation unit 241.

The terminal device private key/certificate transmission unit 243 transmits the pair of the terminal device private key and the terminal device certificate stored by the terminal device private key/certificate storage unit 242 to the terminal device 500.

The recording medium device key pair generation unit 250 generates a recording medium device key pair composed of a recording medium device public key and a recording medium device private key to be embedded in the recording medium device 600.

The certificate generation unit 251 generates a recording medium device certificate by using the root private key stored by the root key pair storage unit 211 to attach a signature to the recording medium device public key generated by the recording medium device key pair generation unit 250. FIG. 5D shows an example of the recording medium device certificate. The recording medium device certificate (FIG. 5D) is composed of a recording medium device ID, a recording medium device public key, accompanying data, and a signature.

The recording medium device private key/certificate storage unit 252 stores, as a pair, the recording medium device private key generated by the recording medium device key pair generation unit 250 and the recording medium device certificate generated by the certificate generation unit 251.

The recording medium device private key/certificate transmission unit 253 transmits the pair of the recording medium device private key and the recording medium device certificate stored by the recording medium device private key/certificate storage unit 252 to the recording medium device 600.

Additional information may be added to the accompanying information. Details are provided below.

### Flow of Key Issuing by Key Issuing Device 200

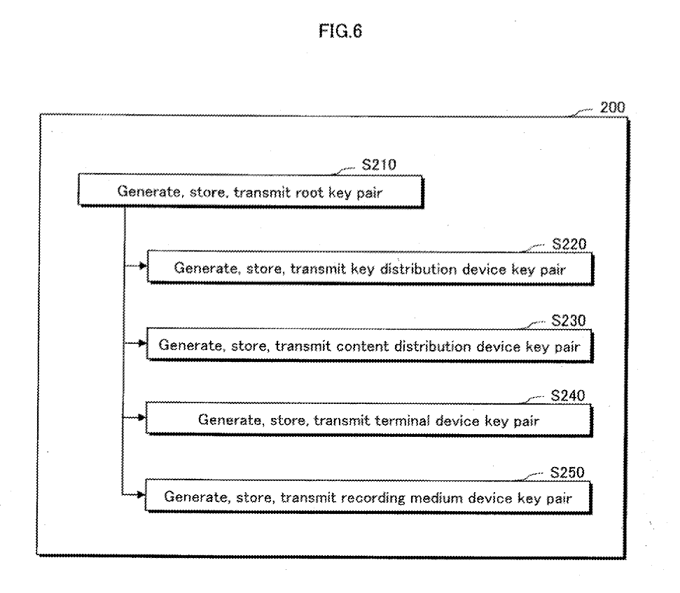

FIG. 6 shows the flow of key issuing by the key issuing device 200.

The key issuing device 200 generates and stores the root key pair of the root public key and the root private key. Furthermore, in response to requests, the root public key is transmitted to the key distribution device 400, the terminal device 500, and the recording medium device 600 (S210).

The key issuing device 200 generates and stores the key pair of the key distribution device public key and the key distribution device private key, transmitting the key pair to the key distribution device 400 (S220).

The key issuing device 200 generates and stores the key pair of the content creation device public key and the content creation device private key, transmitting the key pair to the content creation device 100 (S230).

The key issuing device 200 generates and stores the key pair of the terminal device public key and the terminal device private key, transmitting the key pair to the terminal device 500 (S240).

The key issuing device 200 generates and stores the key pair of the recording medium device public key and the recording medium device private key, transmitting the key pair to the recording medium device 600 (S250).

### Detailed Configuration of Content Distribution Device 300

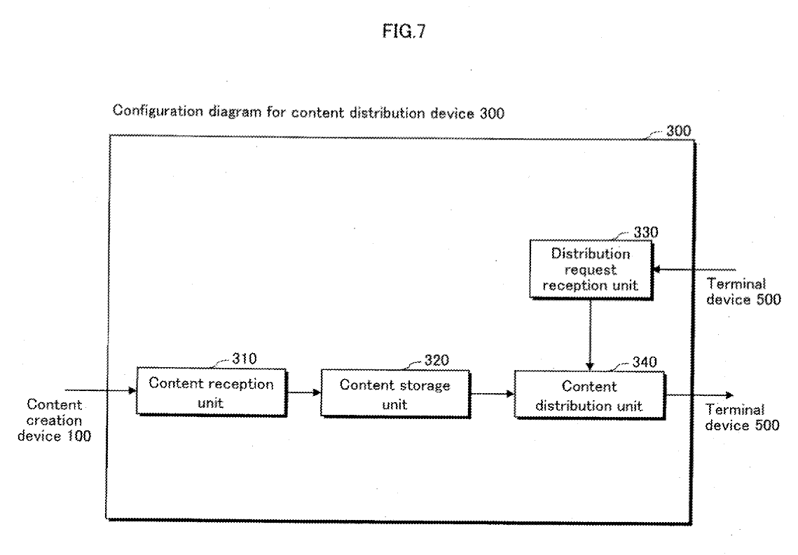

FIG. 7 shows the detailed configuration of the content distribution device 300.

As shown in FIG. 7, the content distribution device 300 includes a content reception unit 310, a content storage unit 320, a distribution request reception unit 330, and a content distribution unit 340.

The content reception unit 310 receives a content from the content creation device 100.

The content storage unit 320 stores the content received by the content reception unit 310.

The distribution request reception unit 330 receives a distribution request from the terminal device 500 and instructs the content distribution unit 340 to distribute a content.

Upon receiving the distribution request from the distribution request reception unit 330, the content distribution unit 340 searches for a corresponding content in the content storage unit 320 and, upon finding the content, distributes the corresponding content to the terminal device 500.

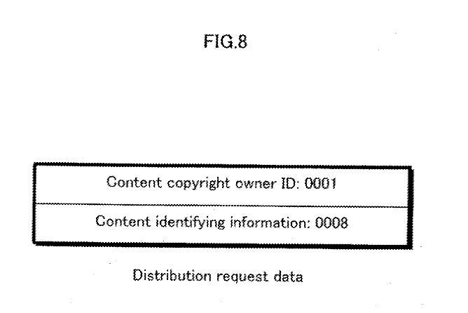

FIG. 8 shows an example of data used in a distribution request. The data for the distribution request is composed of a content copyright owner ID and content identifying information.

### Operational Flow of Content Distribution Device 300

The content distribution device 300 receives and stores a content (S310).

The content distribution device 300 receives a distribution request (S320).

Upon receiving the distribution request, the content distribution device 300 searches for the content corresponding to the content identifying information listed in the data of the distribution request. If the content distribution device 300 finds the content, it distributes the content to the terminal device 500 that issued the request. If the content distribution device 300 does not find the content, it transmits a message to the terminal device 500 that issued the request indicating that the content was not found (S330).

### Detailed Configuration of Key Distribution Device 400

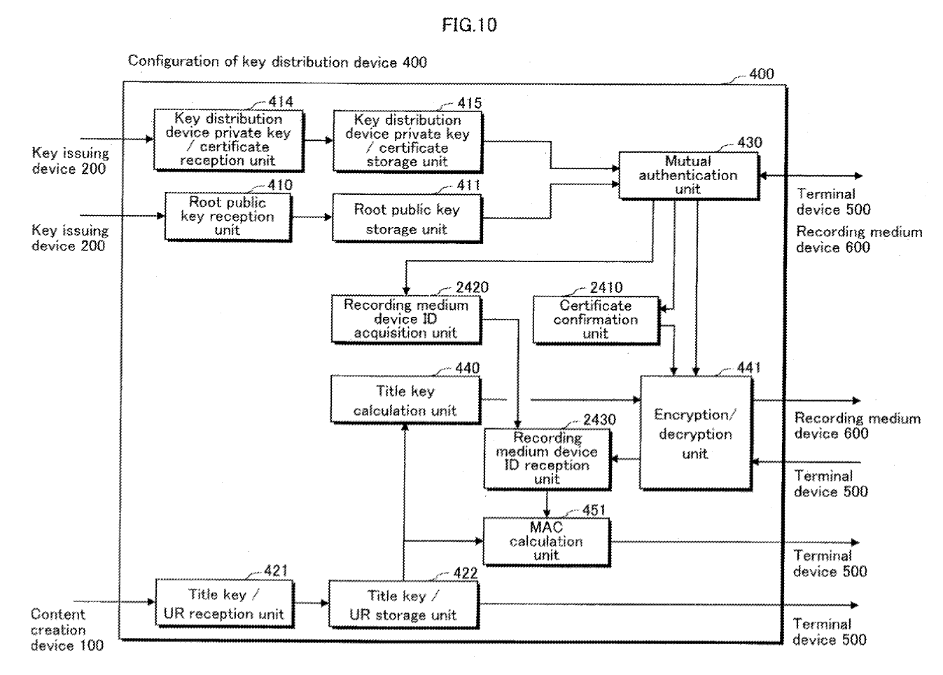

FIG. 10 shows the detailed configuration of the key distribution device 400.

As shown in FIG. 10, the key distribution device 400 includes a root public key reception unit 410, a root public key storage unit 411, a key distribution device private key/certificate reception unit 414, a key distribution device private key/certificate storage unit 415, a title key/UR reception unit 421, a title key/UR storage unit 422, a mutual authentication unit 430, a title key calculation unit 440, an encryption/decryption unit 441, a MAC calculation unit 451, a certificate confirmation unit 2410, a recording medium device ID acquisition unit 2420, and a recording medium device ID reception unit 2430.

The root public key reception unit 410 receives the root public key from the key issuing device 200.

The root public key storage unit 411 stores the root public key received by the root public key reception unit 410.

The key distribution device private key/certificate reception unit 414 receives a key pair of the key distribution device private key/certificate from the key issuing device 200.

The key distribution device private key/certificate storage unit 415 stores the key pair of the key distribution device private key/certificate received by the key distribution device private key/certificate reception unit 414.

The title key/UR reception unit 421 receives the title key and the UR from the content creation device 100.

The title key/UR storage unit 422 stores the title key and the UR received by the title key/UR reception unit 421. The title key/UR storage unit 422 also transmits the stored UR to the terminal device 500 in response to a request from the terminal device 500.

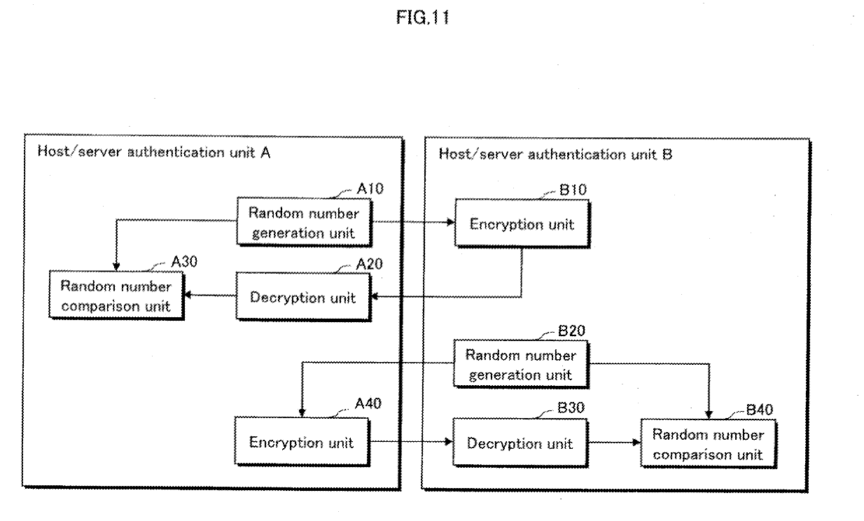

The mutual authentication unit 430 performs mutual authentication with the terminal device 500 or the recording medium device 600 and shares a shared key with the terminal device 500 or the recording medium device 600. An example of mutual authentication is illustrated in FIG. 11.

The title key calculation unit 440 acquires the title key and the UR stored by the title key/UR storage unit 422, calculates a hash value of the UR, and generates a calculated title key by performing a simple, reversible calculation to combine operands, such as XOR, on the hash value and the title key. The title key calculation unit 440 then transmits the result to the recording medium device 600 via the encryption/decryption unit 441.

The encryption/decryption unit 441 encrypts the calculated title key, generated by the title key calculation unit 440, with the shared key generated during the mutual authentication process by the mutual authentication unit 430. The encryption/decryption unit 441 transmits the result to the recording medium device 600.

The MAC calculation unit 451 calculates a Message Authentication Code (MAC) using the title key stored by the title key/UR storage unit 422 and the recording medium device ID received by the recording medium device ID reception unit 2430. The MAC calculation unit 451 transmits the result to the terminal device 500.

The certificate confirmation unit 2410 acquires the certificate of the terminal device 500 or the recording medium device 600 received during mutual authentication by the mutual authentication unit 430, confirms the protocol whose performance is permitted for the terminal device 500 or the recording medium device 600, monitors the encryption/decryption unit 441, and suspends processing if an attempt is made to perform a non-permitted protocol.

The recording medium device ID acquisition unit 2420 confirms the content of the certificate of the recording medium device 600 received during mutual authentication by the mutual authentication unit 430, acquires the recording medium device ID listed in the certificate, and notifies the recording medium device ID reception unit 2430 of the recording medium device ID.

Via the encryption/decryption unit 441, the recording medium device ID reception unit 2430 receives, from the terminal device 500, the recording medium device ID of the recording medium device that is to be written to. Note that at the point at which the recording medium device ID has reached the key distribution device 400, it is encrypted by the shared key. Therefore, before the recording medium device ID is transmitted to the recording medium device ID reception unit 2430, the encryption/decryption unit 441 decrypts it with the shared key so that the recording medium device ID reception unit 2430 can use the original recording medium device ID. Furthermore, it is confirmed whether the recording medium device ID matches the recording medium device ID received from the recording medium device ID acquisition unit 2420. If so, processing continues. Otherwise, processing is controlled, for example by suspending processing.

FIG. 11 shows detailed steps for mutual authentication. Such steps are, for example, as follows.

(a) A random number generation unit A10 of the host/media authentication unit A generates a random number R1 and transmits R1 to the host/media authentication unit B.

(b) An encryption unit B10 of the host/media authentication unit B generates E(Ksc, R1) by encrypting the random number R1 with a unique key Ksc and transmits the result to the host/media authentication unit A.

(c) A decryption unit A20 of the host/media authentication unit A generates D(Ksc, (E(Ksc, R1))) (=R1) by decrypting the received E(Ksc, R1) with the unique key Ksc.

(d) A random number comparison unit A30 of the host/media authentication unit A authenticates the module when the result of decryption in (c) matches the random number generated in (a).

(e) A random number generation unit B20 of the host/media authentication unit B generates a random number R2 and transmits R2 to the host/media authentication unit A.

(f) An encryption unit A40 of the host/media authentication unit A generates E(Ksc, R2) by encrypting the random number R2 with a unique key Ksc and transmits the result to the host/media authentication unit B.

(g) A decryption unit B30 of the host/media authentication unit B generates D(Ksc, (E(Ksc, R2))) (=R2) by decrypting the received E(Ksc, R2) with the unique key Ksc.

(h) The host/media authentication unit B authenticates the other device when the result of decryption in (g) by a random number comparison unit B40 of the host/media authentication unit B matches the random number generated in (e). The host/media authentication unit A and the host/media authentication unit B use, as the shared key, a value acquired by applying a one-way function using Ksc to R1∥R2.

Note that the steps for mutual authentication described above are only an example, and a different method of mutual authentication may be used.

### Distribution Flow of Key Distribution Device 400

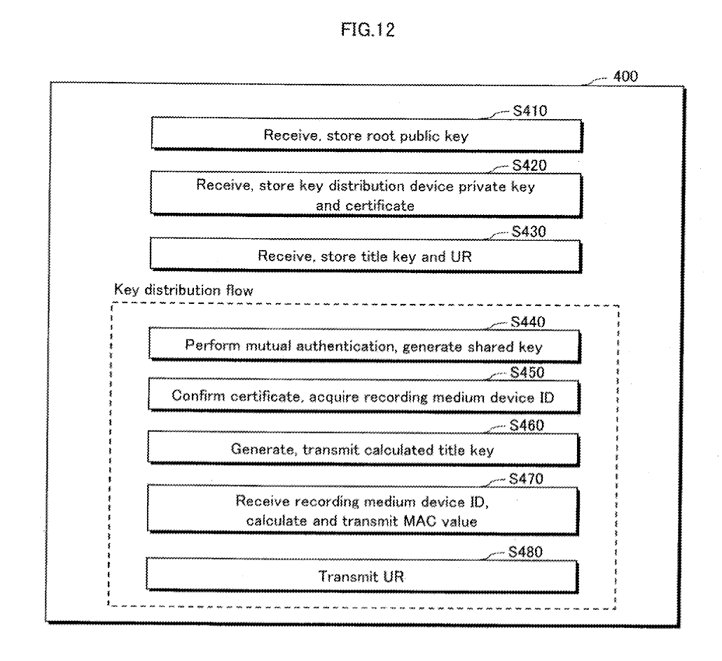

FIG. 12 shows the distribution flow of the key distribution device 400.

The key distribution device 400 receives the root public key from the key issuing device 200 and stores the root public key (S410).

The key distribution device 400 receives the key pair of the key distribution device private key/certificate from the key issuing device 200 and stores the pair key (S420).

The key distribution device 400 receives the title key and the UR from the content creation device 100 and stores the title key and the UR (S430).

Upon receiving a request to transmit the title key from the terminal device 500 or the recording medium device 600, the key distribution device 400 performs steps S440, S450, S460, S470, and S480.

The mutual authentication unit 430 performs mutual authentication with the terminal device 500 or the recording medium device 600 to confirm whether the terminal device 500 or the recording medium device 600 is trustable and to generate a shared key. Data is protected in subsequent communication by using the shared key to encrypt and decrypt the data (S440).

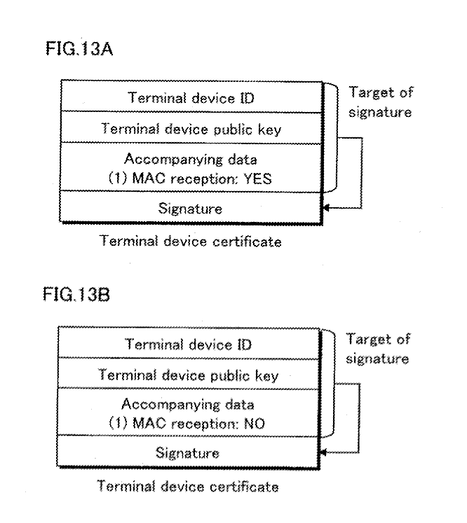

The certificate confirmation unit 2410 acquires the certificate of the terminal device 500 or the recording medium device 600 received during mutual authentication by the mutual authentication unit 430, confirms the protocol whose performance is permitted for the terminal device 500 or the recording medium device 600, monitors the encryption/decryption unit 441, and suspends processing if an attempt is made to perform a non-permitted protocol. FIG. 13A is an example of a certificate for the case when the MAC reception protocol is permitted for the terminal device 500. If the certificate confirmation unit 2410 receives the certificate shown in FIG. 13A, the key distribution device 400 permits processing to receive the recording medium device ID from the terminal device 500 and processing to notify the terminal device 500 of the MAC calculation result. If the certificate confirmation unit 2410 receives the certificate shown in FIG. 13B, the key distribution device 400 does not receive the recording medium device ID from the terminal device 500 or notify the terminal device 500 of the MAC calculation result (S450).

The title key calculation unit 440 acquires the title key and the UR stored by the title key/UR storage unit 422, calculates a hash value of the UR, and generates a calculated title key by performing a simple, reversible calculation to combine operands, such as XOR, on the hash value and the title key. The title key calculation unit 440 then transmits the result to the recording medium device 600 via the encryption/decryption unit 441 (S460).

The recording medium device ID reception unit 2430 receives the recording medium device ID from the recording medium device 600 via the encryption/decryption unit 441 and confirms that the recording medium device ID matches the recording medium device ID acquired by the recording medium device ID acquisition unit 2420. If the IDs do not match, processing is suspended. If the IDs do match, processing continues. The MAC calculation unit 451 calculates a Message Authentication Code (MAC) using the recording medium device ID received by the recording medium device ID reception unit 2430 and the title key stored by the title key/UR storage unit 422, transmitting the MAC value to the terminal device 500 (S470).

The title key/UR storage unit 422 transmits the stored UR to the terminal device 500 (S480).

### Detailed Configuration of Terminal Device 500

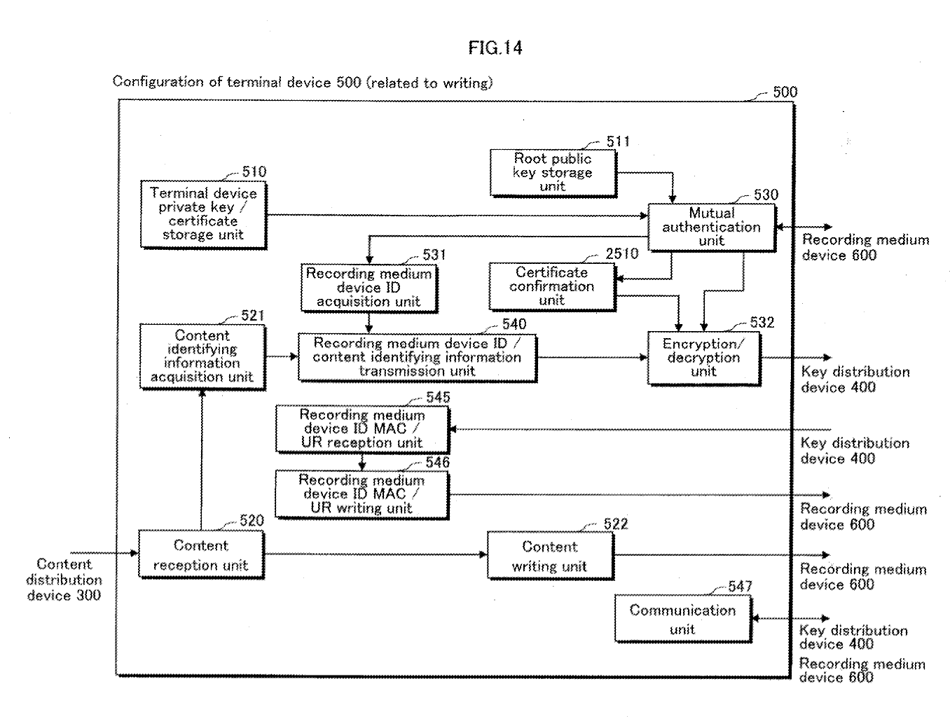

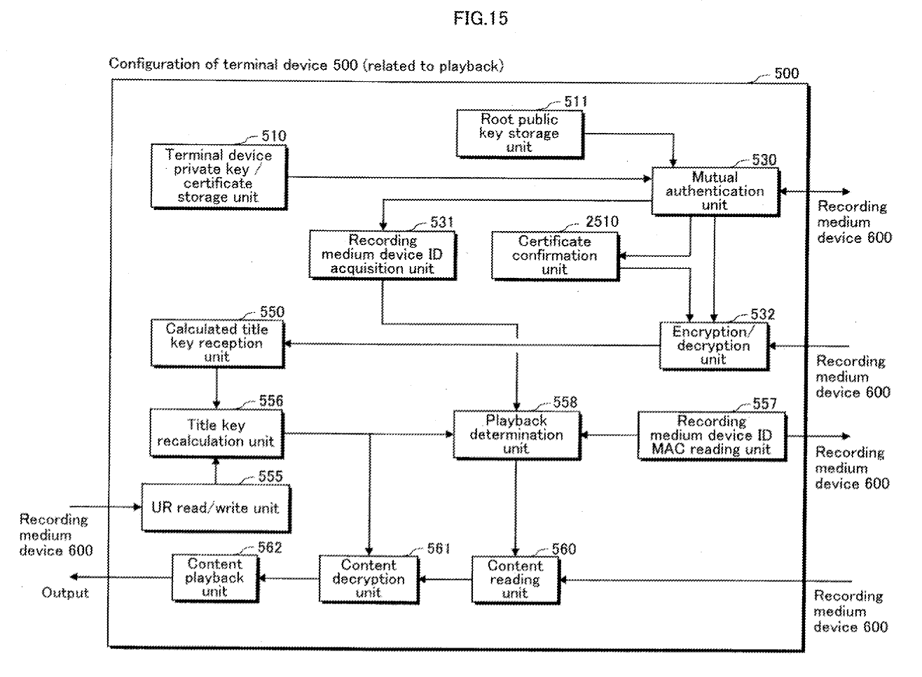

FIGS. 14 and 15 show the detailed configuration of the terminal device 500. FIG. 14 shows the configuration related to how the terminal device 500 coordinates with the content distribution device 300 and the key distribution device 400 to receive a content as well as data necessary for protection and playback of the content, such as keys, and then writes the received information on the recording medium device 600. FIG. 15 shows the configuration related to how the terminal device 500 reads a content as well as data necessary for protection and playback of the content, such as keys, from the recording medium device 600 and plays back the content in the case that the content and the data necessary for protection and playback of the content, such as keys, are already written on the recording medium device 600. Components that are the same for playback processing as for processing related to reception and writing are provided with the same names and numbers, and a duplicate description thereof is omitted.

As shown in FIGS. 14 and 15, the terminal device 500 includes a terminal device private key/certificate storage unit 510, a root public key storage unit 511, a content reception unit 520, a content identifying information acquisition unit 521, a content writing unit 522, a mutual authentication unit 530, a recording medium device ID acquisition unit 531, an encryption/decryption unit 532, a recording medium device ID/content identifying information transmission unit 540, a recording medium device ID MAC/UR reception unit 545, a recording medium device ID MAC/UR writing unit 546, a communication unit 547, a calculated title key reception unit 550, a UR read/write unit 555, a title key recalculation unit 556, a recording medium device ID MAC reading unit 557, a playback determination unit 558, a content reading unit 560, a content decryption unit 561, a content playback unit 562, and a certificate confirmation unit 2510.

The terminal device private key/certificate storage unit 510 stores the key pair of the terminal device private key/terminal device certificate received from the key issuing device 200. Actually, the terminal manufacturing device that manufactures the terminal device 500 writes the key pair of the terminal device private key/terminal device certificate, but this is not related to the essence of the present invention. A detailed description is therefore omitted.

The root public key storage unit 511 stores the root public key received from the key issuing device 200. Actually, the terminal manufacturing device that manufactures the terminal device 500 writes the root public key, but this is not related to the essence of the present invention. A detailed description is therefore omitted.

The content reception unit 520 receives a content from the content distribution device 300.

If content identifying information that can uniquely identify the content, such as a hash table or hash value of the hash table, is embedded in the content received by the content reception unit 520, then the content identifying information acquisition unit 521 acquires the content identifying information.

The content writing unit 522 writes the content received by the content reception unit 520 on the recording medium device 600.

The mutual authentication unit 530 performs host/server mutual authentication with the key distribution device 400 or the recording medium device 600 and shares a shared key with the key distribution device 400 or the recording medium device 600. Note that host/server mutual authentication has already been described with reference to FIG. 11.

The recording medium device ID acquisition unit 531 analyzes the certificate of the recording medium device 600, received during mutual authentication by the mutual authentication unit 530, to acquire the recording medium device ID.

The encryption/decryption unit 532 protects data over the communications channel during communication between the terminal device 500 and the key distribution device 400 or between the terminal device 500 and the recording medium device 600 by using the shared key shared by the mutual authentication unit 530 to encrypt data upon transmission and decrypt data upon reception.

The recording medium device ID/content identifying information transmission unit 540 treats the recording medium device ID acquired by the recording medium device ID acquisition unit 531 as the ID of the recording medium device to be written to and transmits this recording medium device ID as a set, along with the content identifying information acquired by the content identifying information acquisition unit 521, to the key distribution device 400 via the encryption/decryption unit 532.

The recording medium device ID MAC/UR reception unit 545 receives the MAC value of the recording medium device ID from the key distribution device 400 via the encryption/decryption unit 532, the MAC value representing a MAC calculation of the recording medium device ID, transmitted by the recording medium device ID/content identifying information transmission unit 540, the MAC calculation using the title key that protects the content identified by the content identifying information transmitted by the recording medium device ID/content identifying information transmission unit 540. The recording medium device ID MAC/UR reception unit 545 also receives, from the key distribution device 400 without going through the encryption/decryption unit 532, the UR for the content identified by the content identifying information transmitted by the recording medium device ID/content identifying information transmission unit 540.

The recording medium device ID MAC/UR writing unit 546 writes the recording medium device ID MAC and the UR received by the recording medium device ID MAC/UR reception unit 545 on the recording medium device 600.

The calculated title key reception unit 550 receives the calculated title key from the recording medium device 600 via the encryption/decryption unit 532.

The communication unit 547 receives transmission data from the recording medium device 600 and transmits data to the key distribution device 400. The communication unit 547 also receives transmission data from the key distribution device 400 and transmits data to the recording medium device 600. Except for data related to control, such as a notification of termination of communication, the communication unit 547 supports communication between the key distribution device 400 and the recording medium device 600 without knowledge of the content of the communications data. During this communication between the key distribution device 400 and the recording medium device 600, the calculated title key data is protected while being conveyed.

The UR read/write unit 555 reads the UR for a particular content from the recording medium device 600 that stores contents.

The title key recalculation unit 556 calculates the original title key by calculating a hash value for the UR read by the UR read/write unit 555 and performing an XOR operation with the calculated title key received by the calculated title key reception unit 550.

The recording medium device ID MAC reading unit 557 reads, from the recording medium device 600, the recording medium device ID MAC related to the content that is to be played back.

Based on the title key calculated by the title key recalculation unit 556, the playback determination unit 558 calculates the MAC value of the recording medium device ID acquired by the recording medium device ID acquisition unit 531 and determines whether the calculated MAC value matches the MAC value of the recording medium device ID read by the recording medium device ID MAC reading unit 557. If the MAC values match, playback is permitted. Otherwise, playback is controlled, for example by aborting playback and by notifying the user that playback is not possible by displaying a message on the output screen.

When the playback determination unit 558 permits playback, the content reading unit 560 reads the content from the recording medium device 600. When the playback determination unit 558 aborts playback, the content reading unit 560 does not read the content from the recording medium device 600.

The content decryption unit 561 decrypts the content read by the content reading unit 560 using the title key calculated by the title key recalculation unit 556.

The content playback unit 562 plays back the content decrypted by the content decryption unit 561, outputting the content to an output device such as a television.

Note that although processing by the content reading unit 560 has been described as being aborted depending on the result of determination by the playback determination unit 558, processing by the content decryption unit 561 or by the content playback unit 562 may be aborted. Alternatively, output may be aborted after decoding by the content playback unit 562 yet before actual output.

The certificate confirmation unit 2510 acquires the certificate for the recording medium device 600 received during mutual authentication by the mutual authentication unit 530, confirms the protocol whose performance is permitted for the recording medium device 600, monitors the encryption/decryption unit 532, and suspends processing if an attempt is made to perform a non-permitted protocol.

### Processing Flow in Terminal Device 500

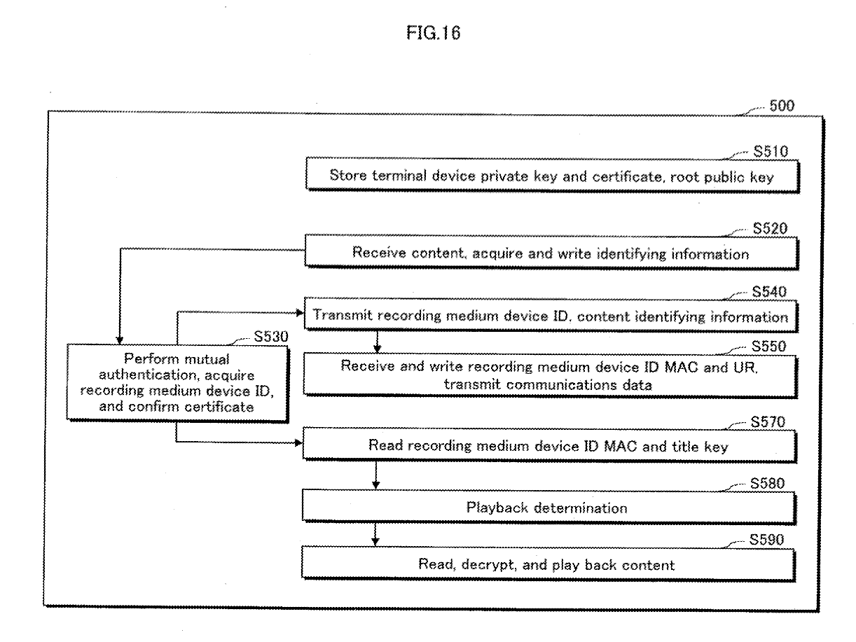

FIG. 16 shows the processing flow in the terminal device 500.

S510 shows the manufacturing flow when manufacturing a terminal device.

The sequence of steps S520, S530, S540, and S550 represent the processing flow both for receiving, from the content distribution device 300 and the key distribution device 400, a content and a UR as well as data necessary for playback of the content, and for recording this information on the recording medium device 600.

The sequence of steps S530, S570, S580, and S590 represent the playback flow for reading and playing back a content and related data from a recording medium device 600 having recorded thereon the content and data necessary for playback of the content.

The terminal device 500 stores the terminal device private key/certificate and the root public key (S510).

The terminal device 500 receives the content from the content distribution device 300, analyzes the content, acquires the content identifying information, confirms that the content identifying information matches content identifying information that has been specified in advance, and writes the content on the recording medium device 600 (S520).

When the terminal device 500 accesses the key distribution device 400 or the recording medium device 600, the mutual authentication unit 530 performs mutual authentication with the key distribution device 400 or the recording medium device 600 to confirm whether the key distribution device 400 or the recording medium device 600 is trustable and to generate a shared key. Data is protected in subsequent communication by using the shared key to encrypt and decrypt the data. The certificate confirmation unit 2510 acquires the certificate of the key distribution device 400 or the recording medium device 600 received during mutual authentication by the mutual authentication unit 530, confirms the protocol whose performance is permitted for the key distribution device 400 or the recording medium device 600, monitors the encryption/decryption unit 532, and suspends processing if an attempt is made to perform a non-permitted protocol.

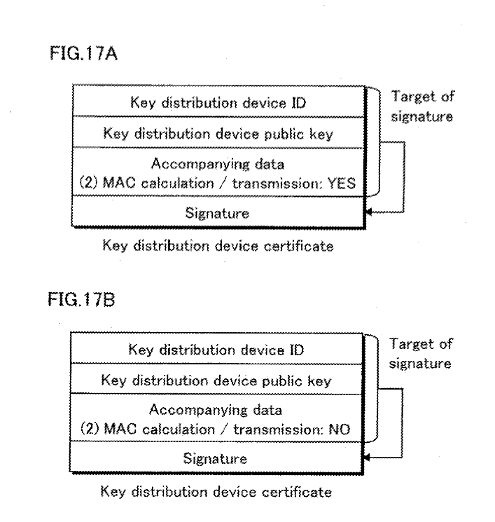

FIG. 17A is an example of a certificate for the case when MAC calculation and transmission are permitted for the key distribution device 400. If the certificate confirmation unit 2510 receives the certificate shown in FIG. 17A, the terminal device 500 permits processing by the recording medium device ID/content identifying information transmission unit 540 to transmit the recording medium device ID and the content identifying information. If the certificate confirmation unit 2410 receives the certificate shown in FIG. 17B, the terminal device 500 does not perform processing by the recording medium device ID/content identifying information transmission unit 540 to transmit the recording medium device ID and the content identifying information.

It is also determined whether the key distribution device 400 or the recording medium device ID of the recording medium device 600, which is determined during the authentication by the mutual authentication unit 530, matches information listed in a revoke file distributed separately. If so, the key distribution device 400 or the recording medium device 600 that is attempting to communicate is regarded as unauthorized. Communication and processing by the mutual authentication unit 530 may then be suspended (S530).

The terminal device 500 transmits the recording medium device ID identified during the mutual authentication and the content identifying information identifying the content to the key distribution device 400 as a set (S540).

The terminal device 500 receives, from the key distribution device 400, the MAC value of the recording medium device ID and the UR. The terminal device 500 writes the UR on the recording medium device 600. Furthermore, the terminal device 500 conveys communications data between the key distribution device 400 and the recording medium device 600. The terminal device 500 cannot become involved with the content of the communications data between the key distribution device 400 and the recording medium device 600; thus data is conveyed safely using the calculated title key (S550).

The terminal device 500 reads the MAC value of the recording medium device ID, the UR, and the calculated title key from the recording medium device 600. Note that since the calculated title key is transmitted after being encrypted with the shared key generated during mutual authentication, the terminal device 500 acquires the calculated title key by decryption with the shared key. Furthermore, the terminal device 500 calculates the hash value of the UR and performs an XOR operation with the calculated title key to yield the original title key (S570).

The terminal device 500 determines whether to allow playback by calculating the MAC value of the recording medium device ID from the recording medium device ID and the title key and confirming that the calculated MAC value matches the MAC value of the recording medium device ID read from the recording medium device 600 (S580).

If the determination of whether to allow playback in S580 is negative, the terminal device 500 aborts playback. If the determination of whether to allow playback in S580 is affirmative, the terminal device 500 reads the content from the recording medium device 600, decrypts the content with the title key, plays back (decodes) the content and outputs the result to a display device such as a monitor (S590).

### Detailed Structure of Recording Medium Device 600

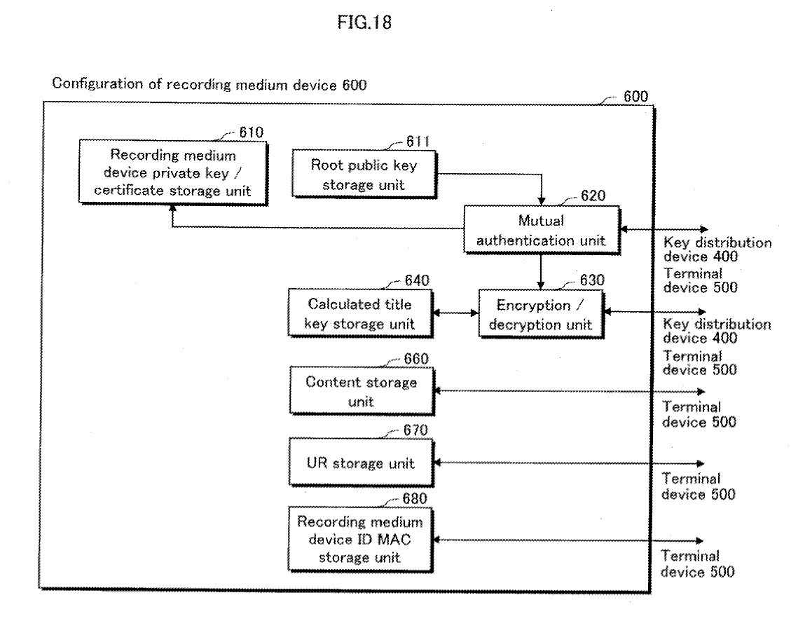

FIG. 18 shows the detailed configuration of the recording medium device 600.

As shown in FIG. 18, the recording medium device 600 includes a recording medium device private key/certificate storage unit 610, a root public key storage unit 611, a mutual authentication unit 620, an encryption/decryption unit 630, a calculated title key storage unit 640, a content storage unit 660, a UR storage unit 670, and a recording medium device ID MAC storage unit 680.

The recording medium device private key/certificate storage unit 610 stores the key pair of the recording medium device private key/recording medium device certificate received from the key issuing device 200. Actually, the recording medium manufacturing device that manufactures the recording medium device 600 writes the key pair of the recording medium device private key/recording medium device certificate, but this is not related to the essence of the present invention. A detailed description is therefore omitted.

The root public key storage unit 611 stores the root public key received from the key issuing device 200. Actually, the recording medium manufacturing device that manufactures the recording medium device writes the root public key, but this is not related to the essence of the present invention. A detailed description is therefore omitted.

The mutual authentication unit 620 performs host/server mutual authentication with the key distribution device 400 or the terminal device 500 and shares a shared key with the key distribution device 400 or the terminal device 500. Note that host/server mutual authentication has already been described with reference to FIG. 11.

The encryption/decryption unit 630 protects data over the communications channel during communication between the recording medium device 600 and the key distribution device 400 or between the recording medium device 600 and the terminal device 500 by using the shared key shared by the mutual authentication unit 620 to encrypt data upon transmission and decrypt data upon reception.

The calculated title key storage unit 640 receives the calculated title key from the key distribution device 400 and stores the calculated title key. The calculated title key storage unit 640 also receives an acquisition request from the terminal device 500 and transmits the calculated title key to the terminal device 500.

The content storage unit 660 receives a content from the terminal device 500 and stores the content. The content storage unit 660 also receives a read request from the terminal device 500 and transmits the content to the terminal device 500.

The UR storage unit 670 receives a UR from the terminal device 500 and stores the UR. The UR storage unit 670 also receives a read request from the terminal device 500 and transmits the UR to the terminal device 500.

The recording medium device ID MAC storage unit 680 receives the recording medium device ID MAC from the terminal device 500 and stores the recording medium device ID MAC. The recording medium device ID MAC storage unit 680 also receives a read request from the terminal device 500 and transmits the recording medium device ID MAC to the terminal device 500.

### Processing Flow in Recording Medium Device 600

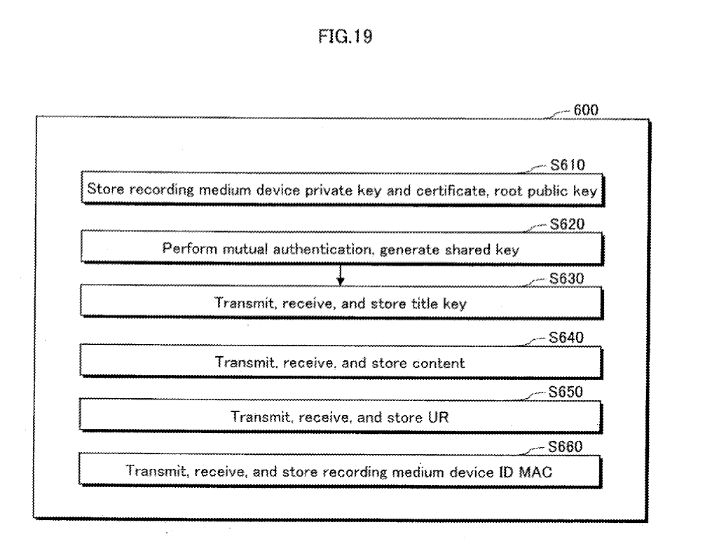

FIG. 19 shows the processing flow in the recording medium device 600.

The recording medium device 600 stores the recording medium device private key/certificate and the root public key (S610).

When the recording medium device 600 is accessed by the key distribution device 400 or the terminal device 500, the mutual authentication unit 620 performs mutual authentication with the key distribution device 400 or the terminal device 500 to confirm whether the key distribution device 400 or the terminal device 500 is trustable and to generate a shared key. Data is protected in subsequent communication by using the shared key to encrypt and decrypt the data. It is also determined whether the terminal device ID of the terminal device 500, which is determined during the authentication by the mutual authentication unit 620, matches information listed in a revoke file distributed separately. If the recording medium device ID matches, the terminal device 500 that is attempting to communicate is regarded as unauthorized, and communication and processing by the mutual authentication unit 620 is suspended (S620).

The recording medium device 600 receives the calculated title key from the key distribution device 400 and stores the calculated title key. The recording medium device 600 also receives an acquisition request from the terminal device 500 and transmits the calculated title key to the terminal device 500 (S630).

The recording medium device 600 receives a content from the terminal device 500 and stores the content. Upon receiving a read request, the recording medium device 600 transmits the content to the terminal device 500 (S640).

The recording medium device 600 receives a UR from the terminal device 500 and stores the UR. Upon receiving a read request, the recording medium device 600 transmits the UR to the terminal device 500 (S650).

The recording medium device 600 receives the MAC value of the recording medium device ID from the terminal device 500 and stores the MAC value. Upon receiving a read request, the recording medium device 600 transmits the MAC value of the recording medium device ID to the terminal device 500 (S660).

### Embodiment 2

### Overall Configuration

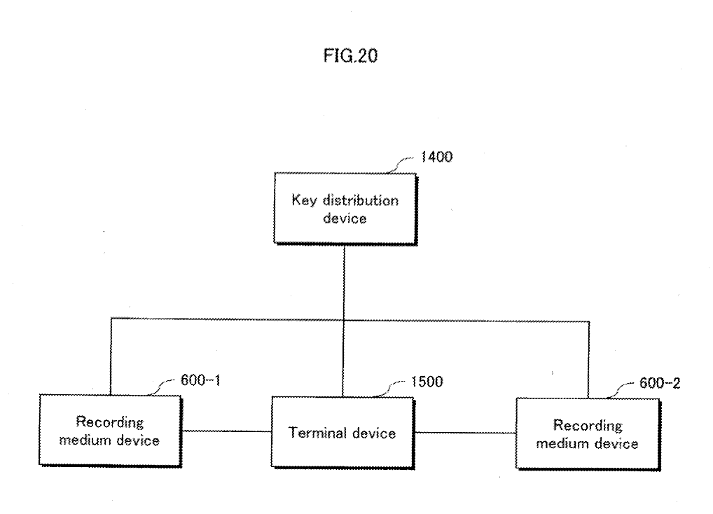

FIG. 20 shows the overall configuration of a content distribution system according to Embodiment 2 of the present invention. The content distribution system includes a key distribution device 1400, a terminal device 1500, a recording medium device 600-1, and a recording medium device 600-2. Note that with regard to the content creation device, key issuing device, and content distribution device, operations are the same as in the content distribution system of Embodiment 1. A description of these operations can therefore be found in Embodiment 1 and is omitted from Embodiment 2. Furthermore, in Embodiment 2, the case of transfer from the recording medium device 600-1 to the recording medium device 600-2 is described with reference to the drawings.

### Detailed Configuration of Key Distribution Device 1400

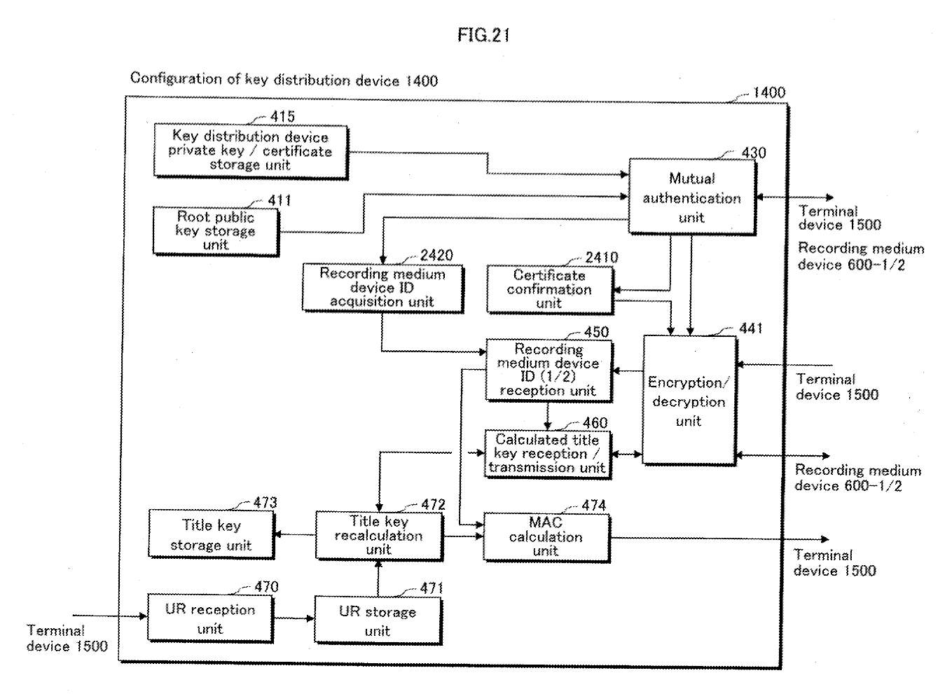

FIG. 21 shows the detailed configuration of the key distribution device 1400.

As shown in FIG. 21, the key distribution device 1400 includes a root public key storage unit 411, a key distribution device private key/certificate storage unit 415, a mutual authentication unit 430, an encryption/decryption unit 441, a recording medium device ID (1/2) reception unit 450, a calculated title key reception/transmission unit 460, a UR reception unit 470, a UR storage unit 471, a title key recalculation unit 472, a title key storage unit 473, a MAC calculation unit 474, a certificate confirmation unit 2410, and a recording medium device ID acquisition unit 2420.

The root public key storage unit 411 stores the root public key.

The key distribution device private key/certificate storage unit 415 stores a key pair of a key distribution device private key/certificate.

The mutual authentication unit 430 performs host/server mutual authentication with the terminal device 1500, the recording medium device 600-1, or the recording medium device 600-2 and shares a shared key with the terminal device 1500, the recording medium device 600-1, or the recording medium device 600-2. Note that host/server mutual authentication has already been described with reference to FIG. 11 in Embodiment 1. A description thereof is thus omitted.

The encryption/decryption unit 441 encrypts the calculated title key, generated by the title key calculation unit 440, with the shared key generated during the mutual authentication process by the mutual authentication unit 430. The encryption/decryption unit 441 transmits the result to the recording medium device 600-1 and the recording medium device 600-2.

The recording medium device ID (1/2) reception unit 450 receives, from the terminal device 1500 via the encryption/decryption unit 441, the recording medium device ID of the recording medium device 600-1, which is the transmitter, and the recording medium device ID of the recording medium device 600-2, which is the receiver. Furthermore, it is determined whether the received recording medium device IDs match the recording medium device IDs (corresponding to 600-1 and 600-2) acquired by the recording medium device ID acquisition unit 2420. When the IDs match, processing continues. If even only one of the IDs does not match, processing is suspended.

The calculated title key reception/transmission unit 460 receives the calculated title key from the recording medium device 600-1 via the encryption/decryption unit 441. Upon receiving an acquisition request, the calculated title key reception/transmission unit 460 also transmits the calculated title key to the recording medium device 600-1 or the recording medium device 600-2 via the encryption/decryption unit 441.

The UR reception unit 470 receives a UR from the terminal device 1500.

The UR storage unit 471 stores the UR received by the UR reception unit 470.

The title key recalculation unit 472 calculates the original title key by calculating a hash value of the UR stored by the UR storage unit 471 and using the hash value to perform an XOR operation on the calculated title key received from the recording medium device 600-1 by the calculated title key reception/transmission unit 460.

The title key storage unit 473 stores the title key calculated by the title key recalculation unit 472.

The MAC calculation unit 474 calculates a Message Authentication Code (MAC) using the title key stored by the title key storage unit 473 and the recording medium device ID (600-1 or 600-2) received by the recording medium device ID (1/2) reception unit 450. The MAC calculation unit 474 transmits the result to the terminal device 1500.

The certificate confirmation unit 2410 acquires the certificate of the terminal device 1500, the recording medium device 600-1, or the recording medium device 600-2 received during mutual authentication by the mutual authentication unit 430, confirms the protocol whose performance is permitted for the terminal device 1500, the recording medium device 600-1, or the recording medium device 600-2, monitors the encryption/decryption unit 441, and suspends processing if an attempt is made to perform a non-permitted protocol.

The recording medium device ID acquisition unit 2420 confirms the content of the certificate of the recording medium device 600-1 or the recording medium device 600-2 received during mutual authentication by the mutual authentication unit 430, acquires the recording medium device ID listed in the certificate, and notifies the recording medium device ID (1/2) reception unit 450 of the recording medium device ID.

### Transfer Flow of Key Distribution Device 1400

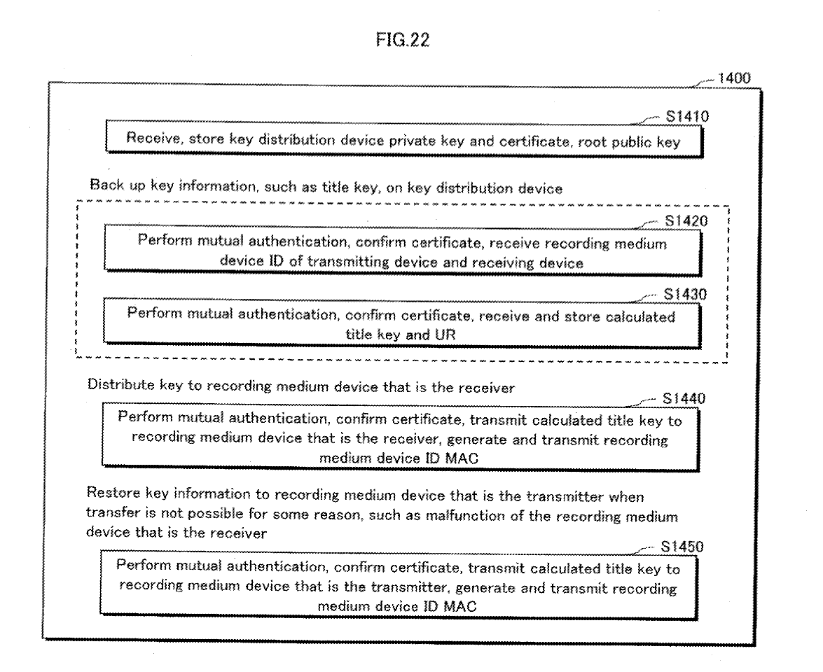

FIG. 22 shows the transfer flow of the key distribution device 1400.

The key distribution device 1400 stores the root public key and the key pair of the key distribution device private key/certificate (S1410).

The mutual authentication unit 430 performs mutual authentication with the terminal device 1500 to confirm whether the terminal device 1500 is trustable and to generate a shared key.

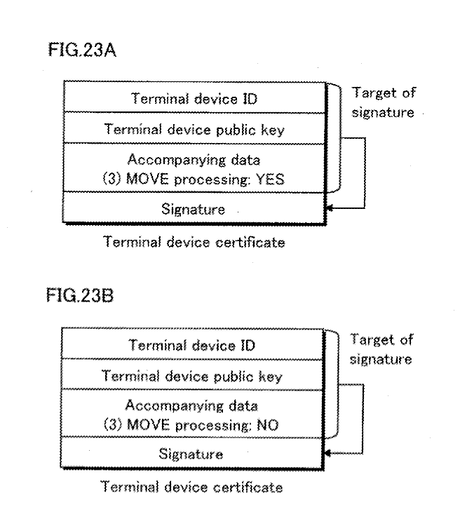

The certificate confirmation unit 2410 acquires the certificate of the terminal device 1500 received during mutual authentication by the mutual authentication unit 430, confirms the protocol whose performance is permitted for the terminal device 1500, monitors the encryption/decryption unit 441, and suspends processing if an attempt is made to perform a non-permitted protocol. FIG. 23A is an example of a certificate for the case when the MOVE protocol is permitted for the terminal device 1500. If the certificate confirmation unit 2410 receives the certificate shown in FIG. 23A, the key distribution device 1400 permits processing to receive the recording medium device ID (600-1 and 600-2) from the terminal device 1500 and processing to notify the terminal device 1500 of the MAC calculation result. If the certificate confirmation unit 2410 receives the certificate shown in FIG. 23B, the key distribution device 1400 does not receive the recording medium device ID from the terminal device 1500 or notify the terminal device 1500 of the MAC calculation result.

The recording medium device ID (1/2) reception unit 450 receives, from the terminal device 1500 via the encryption/decryption unit 441, the recording medium device ID (600-1) of the transmitter and the recording medium device ID (600-2) of the receiver. The recording medium device ID (1/2) reception unit 450 also confirms whether there is a match with the recording medium device ID (600-1) acquired by the recording medium device ID acquisition unit 2420. If the IDs do not match, processing is suspended. If the IDs do match, processing continues (S1420).

The mutual authentication unit 430 performs mutual authentication with the recording medium device 600-1, which is the transmitter, to confirm whether the recording medium device 600-1 is trustable and to generate a shared key.

The certificate confirmation unit 2410 acquires the certificate for the recording medium device 600-1 received during mutual authentication by the mutual authentication unit 430, confirms the protocol whose performance is permitted for the recording medium device 600-1, monitors the encryption/decryption unit 441, and suspends processing if an attempt is made to perform a non-permitted protocol. Correspondence of the recording medium device (600-1) to the calculated title key transmission protocol is determined. If the determination is affirmative, processing continues. Otherwise, processing is suspended.

The calculated title key reception/transmission unit 460 receives the calculated title key from the recording medium device 600-1 via the encryption/decryption unit 441. Via the terminal device 1500, the UR reception unit 470 receives the UR recorded on the recording medium device 600-1 and stores the received UR in the UR storage unit 471. The title key recalculation unit 472 calculates the original title key by calculating a hash value for the UR acquired from the UR storage unit 471 and performing an XOR operation on the calculated title key received by the calculated title key reception/transmission unit 460 from the recording medium device 600-1. The title key storage unit 473 stores the title key yielded by calculation (S1430).

Through the processing in steps S1420 and S1430, the title key and other key information necessary for content playback is safely backed up from the recording medium device 600-1 onto the key distribution device 400. Note that a portion of the data is backed up on the key distribution device 400 via the terminal device 1500.

The mutual authentication unit 430 performs mutual authentication with the recording medium device 600-2, which is the receiver, to confirm whether the recording medium device 600-2 is trustable and to generate a shared key.

The certificate confirmation unit 2410 acquires the certificate for the recording medium device 600-2 received during mutual authentication by the mutual authentication unit 430, confirms the protocol whose performance is permitted for the recording medium device 600-2, monitors the encryption/decryption unit 441, and suspends processing if an attempt is made to perform a non-permitted protocol. Correspondence of the recording medium device (600-2) to the calculated title key transmission protocol is determined. If the determination is affirmative, processing continues. Otherwise, processing is suspended.

It is also confirmed whether the recording medium device ID of the device which is the receiver, received from the terminal device 1500, matches the recording medium device ID (600-2) acquired by the recording medium device ID acquisition unit 2420. If the IDs do not match, processing is suspended. If the IDs do match, processing continues. The calculated title key reception/transmission unit 460 transmits the calculated title key received by the calculated title key reception/transmission unit 460 from the recording medium device 600-1 as is to the recording medium device 600-2 via the encryption/decryption unit 441. The MAC calculation unit 474 uses the title key stored by the title key storage unit 473 to calculate the MAC value of the recording medium device ID of the device which is the receiver, received by the recording medium device ID (1/2) reception unit 450. The MAC calculation unit 474 transmits the calculated MAC value to the terminal device 1500 (S1440).

Through the processing in step S1440, the key data, such as the title key, which had been temporarily backed up on the key distribution device 1400, is safely transferred to the recording medium device 600-2, which is the receiver. By using the content and the key data recorded on the recording medium device 600-2, a content can be played back by following the playback flow shown in FIG. 16 of Embodiment 1.

The following describes a restoration flow in step S1450 for alternatively transferring key data to the recording medium device 600-1, which is the transmitter, when key data cannot be transferred to the recording medium device 600-2, which is the receiver, due to malfunction or another cause.

Upon determining that key data cannot be transferred to the recording medium device 600-2, which is the receiver, and that the key data is to be transferred to the recording medium device 600-1, which is the transmitter, then the mutual authentication unit 430 performs mutual authentication to confirm whether the recording medium device 600-1 is trustable and to generate a shared key.

The certificate confirmation unit 2410 acquires the certificate for the recording medium device 600-1 received during mutual authentication by the mutual authentication unit 430, confirms the protocol whose performance is permitted for the recording medium device 600-1, monitors the encryption/decryption unit 441, and suspends processing if an attempt is made to perform a non-permitted protocol. Correspondence of the recording medium device (600-1) to the calculated title key transmission protocol is determined. If the determination is affirmative, processing continues. Otherwise, processing is suspended.

It is also confirmed whether the recording medium device ID of the device which is the transmitter, received from the terminal device 1500, matches the recording medium device ID (600-1) acquired by the recording medium device ID acquisition unit 2420. If the IDs do not match, transmission of key data to the recording medium device 600-1 may be aborted. The calculated title key reception/transmission unit 460 retransmits the calculated title key received from the recording medium device 600-1 as is to the recording medium device 600-1 via the encryption/decryption unit 441. The MAC calculation unit 474 uses the title key stored by the title key storage unit 473 to calculate the MAC value of the recording medium device ID of the device which is the receiver, received by the recording medium device ID (1/2) reception unit 450. The MAC calculation unit 474 transmits the calculated MAC value to the terminal device 1500 (S1450).

### Detailed Configuration of Terminal Device 1500

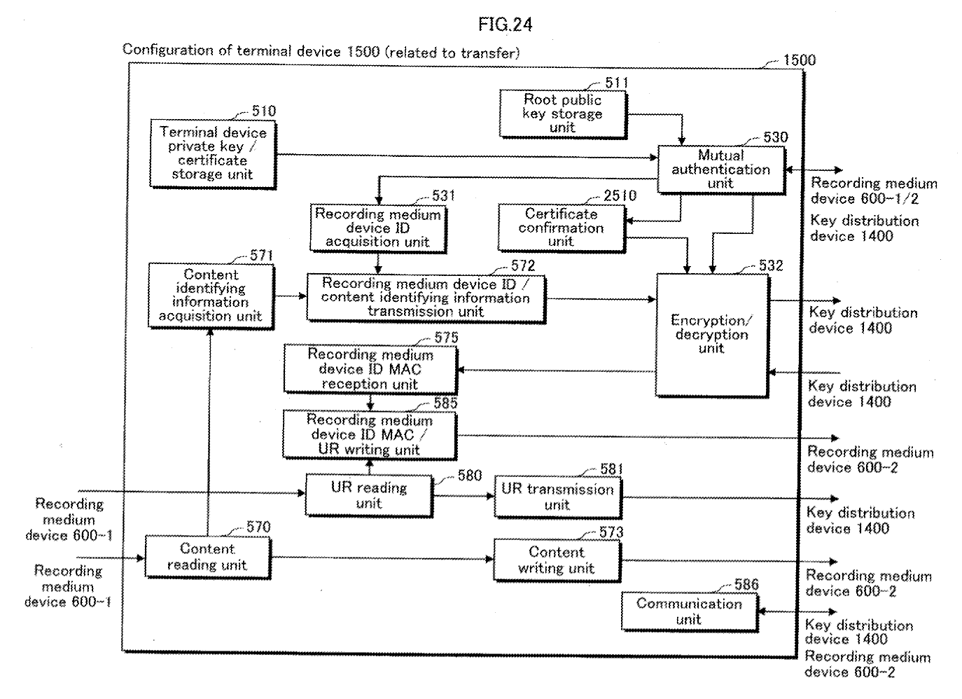

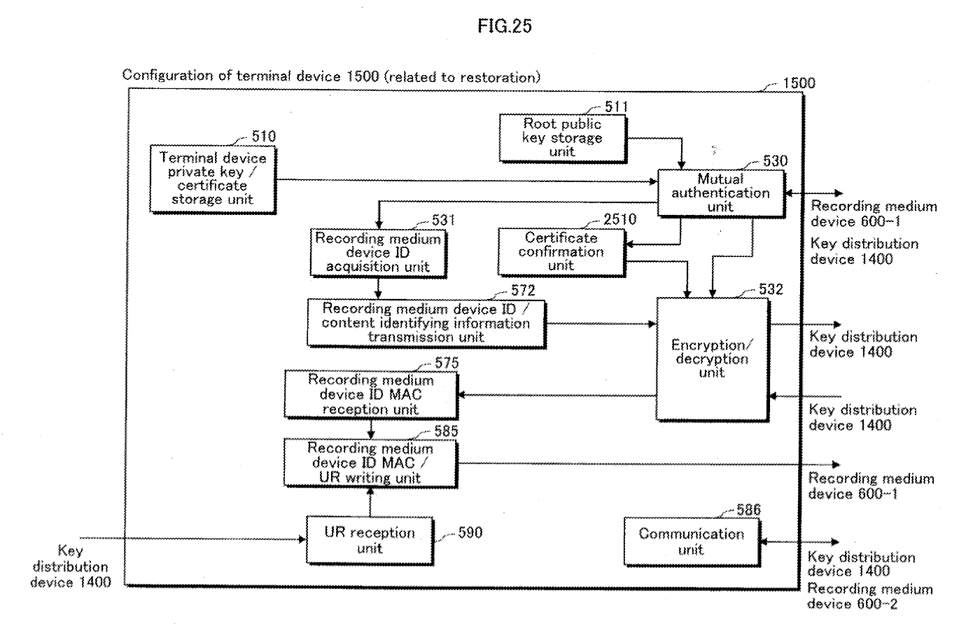

FIGS. 24 and 25 show the detailed configuration of the terminal device 1500. The terminal device 1500 in FIG. 24 coordinates with the key distribution device 1400, the recording medium device 600-1, and the recording medium device 600-2 for safe transfer of a content and of key data necessary for protection and playback of the content from the recording medium device 600-1 to the recording medium device 600-2. FIG. 25 shows a structure for restoring key data to the recording medium device 600-1, which is the transmitter, when a problem occurs in the recording medium device 600-2, which is the receiver, in the example of transfer shown in FIG. 24. Structures that overlap with the structure related to writing and the structure related to playback as described in FIGS. 14 and 15 of Embodiment 1 are provided with the same names and numbers, and the description thereof is simplified.

As shown in FIGS. 24 and 25, the terminal device 1500 includes a terminal device private key/certificate storage unit 510, a root public key storage unit 511, a mutual authentication unit 530, a recording medium device ID acquisition unit 531, an encryption/decryption unit 532, a content reading unit 570, a content identifying information acquisition unit 571, a recording medium device ID/content identifying information transmission unit 572, a content writing unit 573, a recording medium device ID MAC reception unit 575, a UR reading unit 580, a UR transmission unit 581, a recording medium device ID MAC/UR writing unit 585, a communication unit 586, a UR reception unit 590, and a certificate confirmation unit 2510.

The terminal device private key/certificate storage unit 510 stores a key pair of the terminal device private key/terminal device certificate received from the key issuing device 200. Actually, the terminal manufacturing device that manufactures the terminal device 1500 writes the key pair of the terminal device private key/terminal device certificate, but this is not related to the essence of the present invention. A detailed description is therefore omitted.

The root public key storage unit 511 stores a root public key received from the key issuing device 200. Actually, the terminal manufacturing device that manufactures the terminal device 1500 writes the root public key, but this is not related to the essence of the present invention. A detailed description is therefore omitted.

The mutual authentication unit 530 performs mutual authentication with the key distribution device 400 or with the recording medium device 600-1 and the recording medium device 600-2 and shares a shared key with the key distribution device 400 or with the recording medium device 600-1 and the recording medium device 600-2. Note that mutual authentication has already been described with reference to FIG. 11.

The recording medium device ID acquisition unit 531 analyzes the certificate of the recording medium device 600-1 and of the recording medium device 600-2, received during mutual authentication by the mutual authentication unit 530, to acquire the recording medium device Ms.

The encryption/decryption unit 532 protects data over the communications channel during communication between the terminal device 1500 and the key distribution device 400, between the terminal device 1500 and the recording medium device 600-1, or between the terminal device 1500 and the recording medium device 600-2 by using the shared key shared by the mutual authentication unit 530 to encrypt data upon transmission and decrypt data upon reception.

The content reading unit 570 reads the content from the recording medium device 600-1.

If content identifying information that can uniquely identify the content, such as a hash table or hash value of the hash table, is embedded in the content read by the content reading unit 570, then the content identifying information acquisition unit 571 acquires the content identifying information.

The recording medium device ID/content identifying information transmission unit 572 transmits to the key distribution device 1400, via the encryption/decryption unit 532, a set of (i) the recording medium device ID of the recording medium device 600-1, acquired by the recording medium device ID acquisition unit 531, as the transmitter, (ii) the medium device ID of the recording medium device 600-2, acquired by the recording medium device ID acquisition unit 531, as the receiver, and (iii) the content identifying information acquired by the content identifying information acquisition unit 571.

The content writing unit 573 writes the content read by the content reading unit 570 on the recording medium device 600-2.

The recording medium device ID MAC reception unit 575 receives, via the encryption/decryption unit 532, the MAC value of the recording medium device ID (600-1) for the transmitter or the MAC value of the recording medium device ID (600-2) for the receiver as transmitted by the recording medium device ID/content identifying information transmission unit 572 and calculated using the title key used to encrypt the content corresponding to the content identifying information transmitted by the recording medium device ID/content identifying information transmission unit 572.

The UR reading unit 580 reads the UR from the recording medium device 600-1.

The UR transmission unit 581 transmits the UR read by the UR reading unit 580 to the key distribution device 400.

The recording medium device ID MAC/UR writing unit 585 writes the MAC value of the recording medium device ID (600-2) received by the recording medium device ID MAC reception unit 575 and the UR read by the UR reading unit 580 on the recording medium device 600-2. The recording medium device ID MAC/UR writing unit 585 also writes the MAC value of the recording medium device ID (600-1) received by the recording medium device ID MAC reception unit 575 and the UR received by the UR reception unit 590 on the recording medium device 600-1.

The communication unit 586 receives transmission data from the recording medium device 600-1 or the recording medium device 600-2 and transmits data to the key distribution device 1400. The communication unit 586 also receives transmission data from the key distribution device 1400 and transmits data to the recording medium device 600-1 or the recording medium device 600-2. Except for data related to control, such as a notification of termination of communication, the communication unit 586 supports communication between the key distribution device 1400 and the recording medium device 600-2 or the recording medium device 600-1 without knowledge of the content of the communication data. During this communication between the key distribution device 1400 and the recording medium device 600-1 or the recording medium device 600-2, the calculated title key data is protected while being conveyed.

The UR reception unit 590 receives a UR from the key distribution device 1400.

The certificate confirmation unit 2510 acquires the certificate for the recording medium device 600-1/2 received during mutual authentication by the mutual authentication unit 530, confirms the protocol whose performance is permitted for the recording medium device 600-1/2, monitors the encryption/decryption unit 532, and suspends processing if an attempt is made to perform a non-permitted protocol.

### Transfer Flow in Terminal Device 1500

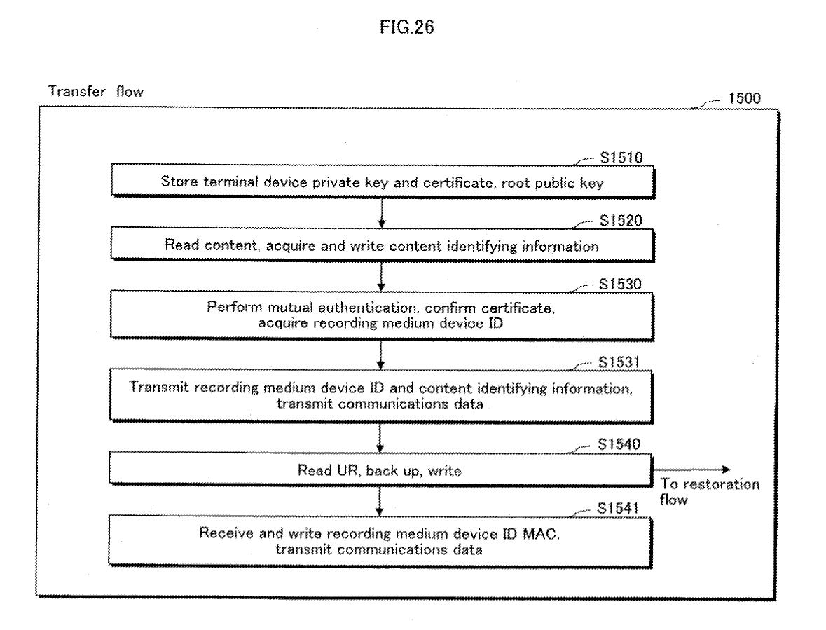

FIG. 26 shows the processing flow in the terminal device 1500.

The terminal device 1500 pre-stores the terminal device private key/certificate and the root public key (S1510).

The terminal device 1500 reads the content from the recording medium device 600-1, analyzes the content, acquires the content identifying information, confirms that the content identifying information matches content identifying information that has been specified in advance, and writes the content on the recording medium device 600-2 (S1520).

The terminal device 1500 confirms whether the recording medium device 600-1 and the recording medium device 600-2 are trustable by the mutual authentication unit 530 performing mutual authentication with the recording medium device 600-1 and the recording medium device 600-2.

The terminal device 1500 acquires the recording medium device ID for the recording medium device 600-1, which is the transmitter, and the recording medium device ID for the recording medium device 600-2, which is the receiver, as specified during mutual authentication. The mutual authentication unit 530 performs mutual authentication with the key distribution device 1400 to confirm whether the key distribution device 1400 is trustable and to generate a shared key. Data is protected in subsequent communication by using the shared key to encrypt and decrypt the data. Furthermore, the certificate confirmation unit 2510 acquires the certificate for the key distribution device 1400 received during mutual authentication by the mutual authentication unit 530, confirms the protocol whose performance is permitted for the key distribution device 1400, monitors the encryption/decryption unit 532, and suspends processing if an attempt is made to perform a non-permitted protocol.

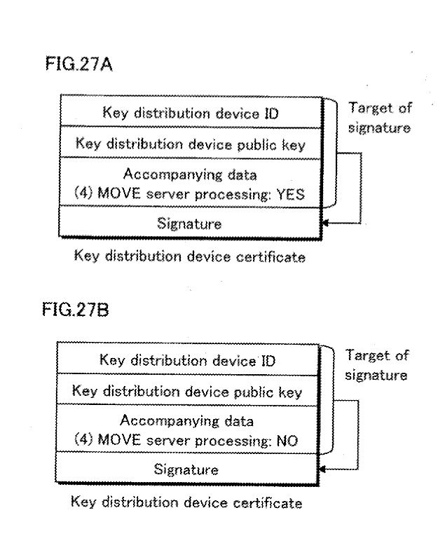

FIG. 27A is an example of a certificate for the case when MOVE server processing is permitted for the key distribution device 1400. If the certificate confirmation unit 2510 receives the certificate shown in FIG. 27A, the terminal device 1500 permits processing by the recording medium device ID/content identifying information transmission unit 572 to transmit the recording medium device ID and the content identifying information. If the certificate confirmation unit 2410 receives the certificate shown in FIG. 27B, the terminal device 1500 does not perform processing by the recording medium device ID/content identifying information transmission unit 572 to transmit the recording medium device ID and the content identifying information (S1530).

The content identifying information specified in step S1520, as well as the recording medium device ID for the receiver and the recording medium device ID for the transmitter specified by the mutual authentication unit 530, are transmitted as a set to the key distribution device 1400 via the encryption/decryption unit 532. Furthermore, the terminal device 1500 transmits communications data between the key distribution device 1400 and the recording medium device 600-1. The terminal device 1500 cannot become involved with the content of the communications data between the key distribution device 1400 and the recording medium device 600-1; thus data is conveyed safely using the calculated title key (S1531).

The UR reading unit 580 reads the UR from the recording medium device 600-1, and the UR transmission unit 581 transmits the UR to the key distribution device 1400, thereby backing up a copy of the UR in the key distribution device 400 (S1540).

The recording medium device ID MAC reception unit 575 receives, via the encryption/decryption unit 532, the MAC value of the recording medium device ID (600-2) for the receiver as transmitted by the recording medium device 1D/content identifying information transmission unit 572 and calculated using the title key used to encrypt the content corresponding to the content identifying information transmitted by the recording medium device ID/content identifying information transmission unit 572. The recording medium device ID MAC/UR writing unit 585 writes the MAC value received by the recording medium device ID MAC reception unit 575 and the UR read by the UR reading unit 580 on the recording medium device 600-2 as a set. Furthermore, the terminal device 1500 conveys communications data between the key distribution device 1400 and the recording medium device 600-2. The terminal device 1500 cannot become involved with the content of the communications data between the key distribution device 1400 and the recording medium device 600-2; thus data is conveyed safely using the calculated title key (S1541).

### Restoration Flow in Terminal Device 1500

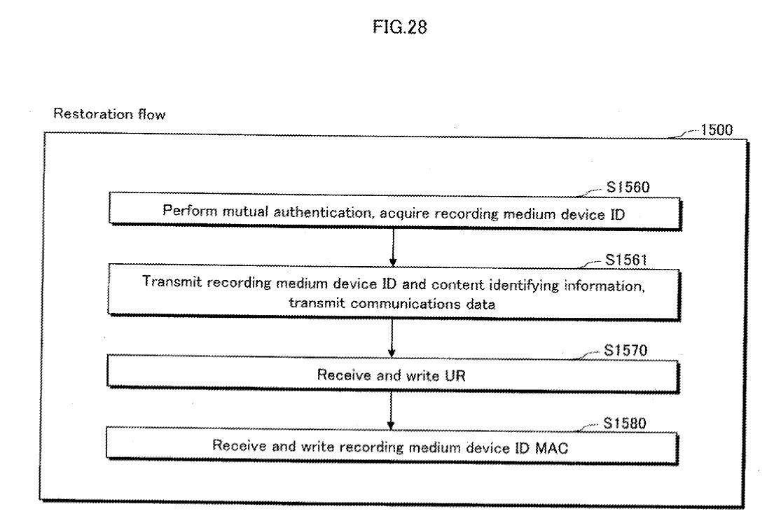

FIG. 28 shows the restoration flow in the terminal device 1500.

In the restoration flow, key data is restored from the key distribution device 1400 to the recording medium device 600-1 when it is determined that the key data cannot be transferred to the receiver, i.e. the recording medium device 600-2, in the transfer flow shown in FIG. 26 due to malfunction of the recording medium device 600-2 or the like.

The terminal device 1500 confirms whether the recording medium device 600-1 is trustable by the mutual authentication unit 530 performing mutual authentication with the recording medium device 600-1. The terminal device 1500 acquires the recording medium device ID for the recording medium device 600-1 as specified during mutual authentication. The mutual authentication unit 530 performs mutual authentication with the key distribution device 400 to confirm whether the key distribution device 1400 is trustable and to generate a shared key. Data is protected in subsequent communication by using the shared key to encrypt and decrypt the data. Furthermore, the certificate confirmation unit 2510 acquires the certificate for the key distribution device 1400 received during mutual authentication by the mutual authentication unit 530, confirms the protocol whose performance is permitted for the key distribution device 1400, monitors the encryption/decryption unit 532, and suspends processing if an attempt is made to perform a non-permitted protocol.

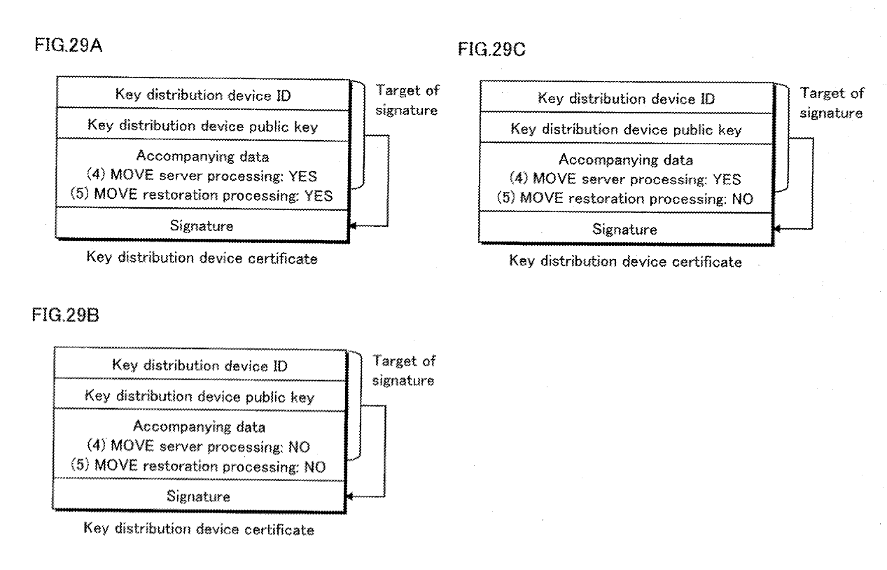

FIG. 29A is an example of a certificate for the case when MOVE restoration processing is permitted for the key distribution device 1400. If the certificate confirmation unit 2510 receives the certificate shown in FIG. 29A, the terminal device 1500 permits processing by the recording medium device ID/content identifying information transmission unit 572 to transmit the recording medium device ID and the content identifying information. If the certificate confirmation unit 2410 receives the certificate shown in FIG. 29B or in FIG. 29C (cases in which restoration is not permitted), the terminal device 1500 does not perform processing by the recording medium device ID/content identifying information transmission unit 572 to transmit the recording medium device ID and the content identifying information (S1560).

The content identifying information specified in step S1520, as well as the recording medium device ID specified by the mutual authentication unit 530, are transmitted as a set to the key distribution device 1400 via the encryption/decryption unit 532. Furthermore, the terminal device 1500 conveys communications data between the key distribution device 1400 and the recording medium device 600-1. The terminal device 1500 cannot become involved with the content of the communications data between the key distribution device 1400 and the recording medium device 600-1; thus data is conveyed safely using the calculated title key (S1561).

The UR reception unit 590 receives the UR from the key distribution device 1400 and writes the UR on the recording medium device 600 (S1570).

The recording medium device ID MAC reception unit 575 receives, via the encryption/decryption unit 532, the MAC value of the recording medium device ID (600-1) as transmitted by the recording medium device ID/content identifying information transmission unit 572 and calculated using the title key used to encrypt the content corresponding to the content identifying information transmitted by the recording medium device ID/content identifying information transmission unit 572. The recording medium device ID MAC/UR writing unit 585 writes the MAC value received by the recording medium device ID MAC reception unit 575 and the UR received by the UR reception unit 590 on the recording medium device 600-1 as a set (S1580).

### Embodiment 3

### Overall Configuration

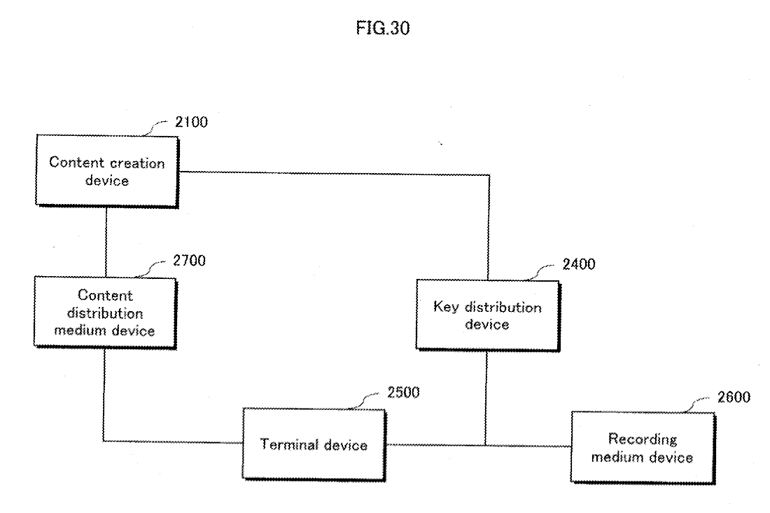

FIG. 30 shows the overall configuration of a content distribution system according to Embodiment 3 of the present invention. The content distribution system includes a content creation device 2100, a content distribution medium device 2700, a key distribution device 2400, a terminal device 2500, and a recording medium device 2600. Note that with regard to the key issuing device, operations are the same as in the content distribution system of Embodiment 1. A description of these operations can therefore be found in Embodiment 1 and is omitted from Embodiment 3. Furthermore, in the content distribution system of Embodiment 3, the structure for copying of a content from a content distribution medium device to a recording medium device and transfer of a key from a key distribution device to the recording medium device is described in detail with reference to the figures. The content distribution medium device 2700 is typified by a commercially sold medium device, such as a Blu-ray Disc™ or a DVD-ROM, that includes a pre-recorded content. Note that the content distribution medium device 2700 may be a readable recording medium such as an SD card or a memory stick, or instead of being a physical medium, may indicate a content that only exists electronically, in which case only a number is distributed, with the content being downloaded from a server.

### Detailed Configuration of Content Creation Device 2100

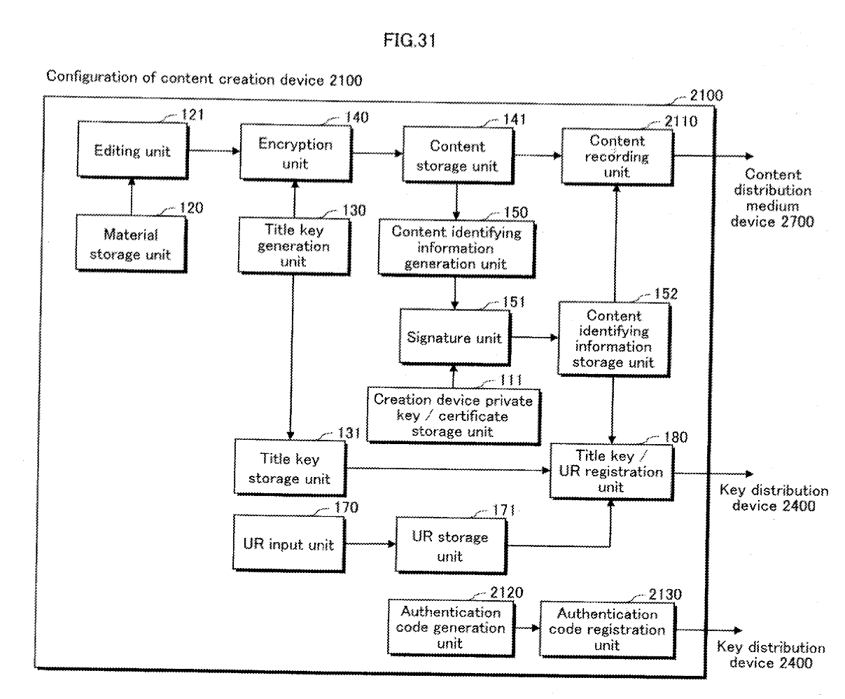

FIG. 31 shows the detailed configuration of the content creation device 2100.

As shown in FIG. 31, the content creation device 2100 includes a creation device private key/certificate storage unit 111, a material storage unit 120, a editing unit 121, a title key generation unit 130, a title key storage unit 131, an encryption unit 140, a content storage unit 141, a content identifying information generation unit 150, a signature unit 151, a content identifying information storage unit 152, a UR input unit 170, a UR storage unit 171, a title key/UR registration unit 180, a content recording unit 2110, an authentication code generation unit 2120, and an authentication code registration unit 2130.

The creation device private key/certificate storage unit 111 stores the key pair of the creation device private key/certificate received by the creation device private key/certificate reception unit 110.

The material storage unit 120 stores material such as video and audio for a movie or the like. Creation of the actual video and audio is not related to the present invention and an explanation thereof is thus omitted from this description.

The editing unit 121 edits the material stored by the material storage unit 120.

The title key generation unit 130 generates a title key. The title key is, for example, a 128-bit random number.

The title key storage unit 131 stores the title key generated by the title key generation unit 130.

The encryption unit 140 encrypts the material edited by the editing unit 121 using the title key stored by the title key storage unit in order to generate content. Unless otherwise noted, “content” hereinafter refers to content that has been encrypted.

The content storage unit 141 stores the content encrypted by the encryption unit 140.

The content identifying information generation unit 150 generates content identifying information from the content stored by the content storage unit 141. For example, the content identifying information generation unit 150 divides the content into sections, calculates a hash value for each section, and lists the hash values in a hash table. The content identifying information generation unit 150 may then calculate a hash value for the hash table and use this hash value as the content identifying information for identifying the content.

Furthermore, the content identifying information generation unit 150 may transmit the hash table to the key issuing device 200. The key issuing device 200 may then assign a unique value to the hash table, append the unique value to the hash table, and provide the entire data with a signature to generate data with a countermeasure against tampering. The key issuing device 200 may then return the data to the content creation device 2100. The content identifying information generation unit 150 may use the unique value assigned by the key issuing device 200 as the content identifying information.

The signature unit 151 may sign the content identifying information generated by the content identifying information generation unit 150 using the content creation device private key stored by the creation device private key/certificate storage unit 111 in order to protect the content identifying information from tampering. Note that as exemplified by the description of the content identifying information generation unit 150, when the key issuing device 200 attaches a signature, the signature provided by the signature unit 151 becomes redundant and may therefore be omitted.

The content identifying information storage unit 152 stores the content identifying information generated by the signature unit 151 and the content identifying information generation unit 150.

The UR input unit 170 accepts input of a UR representing conditions for playback or transfer of content recorded on a recording medium device.

The UR storage unit 171 stores the UR input by the UR input unit 170.

The title key/UR registration unit 180 registers, in the key distribution device 400, the title key stored by the title key storage unit 131 and the UR stored by the UR storage unit 171.

As the content, the content recording unit 2110 records, on the content distribution medium device 2700, the content stored by the content storage unit 141 and the hash table and the like generated by the content identifying information generation unit 150. The hash table may be omitted.

The authentication code generation unit 2120 generates as many authentication codes as the number of content distribution medium devices 2700 being manufactured.

The authentication code registration unit 2130 registers the authentication codes generated by the authentication code generation unit 2120 in the key distribution device 2400.

### Creation Flow of Content Creation Device 2100

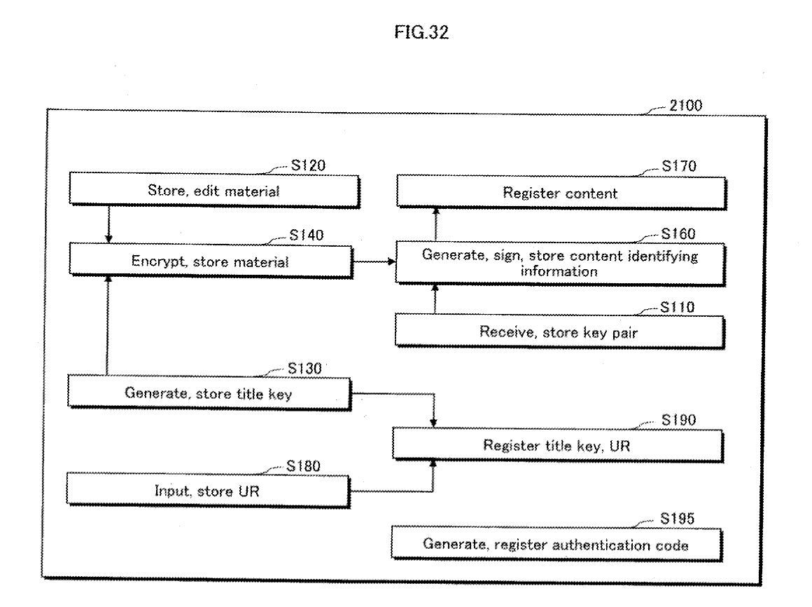

FIG. 32 shows the creation flow of the content creation device 2100.

The creation device private key/certificate storage unit 111 stores a key pair of a creation device private key/certificate (S110).

The editing unit 121 edits the material stored by the material storage unit 120 (S120).

The title key generation unit 130 generates a title key and stores the title key in the title key storage unit 131 (S130).

The encryption unit 140 encrypts the material edited by the editing unit 121 with the title key stored by the title key storage unit 131 and stores the result in the content storage unit 141 (S140).

The content identifying information generation unit 150 reads the content stored by the content storage unit 141 and generates content identifying information that is unique to the content. Additionally, the signature unit 151 attaches a signature to the content identifying information generated by the content identifying information generation unit 150 and stores the result in the content identifying information storage unit 152 (S160).

The content recording unit 2110 records the content stored in the content storage unit 141 on the content distribution medium device 2700 (S170).

A person such as a user of the content creation device 2100 uses the UR input unit 170 to input a UR, which represents rules related to playback and transfer of a content. The UR storage unit 171 stores the UR (S180).

The title key/UR registration unit 180 registers a combination of the title key stored by the title key storage unit 131 and the UR stored by the UR storage unit 171 in the key distribution device 400 (S190).

The authentication code generation unit 2120 generates as many authentication codes as the number of content distribution medium devices 2700 being manufactured. The authentication code registration unit 2130 registers the authentication codes generated by the authentication code generation unit 2120 in the key distribution device 2400 (S195).

### Detailed Configuration of Key Distribution Device 2400

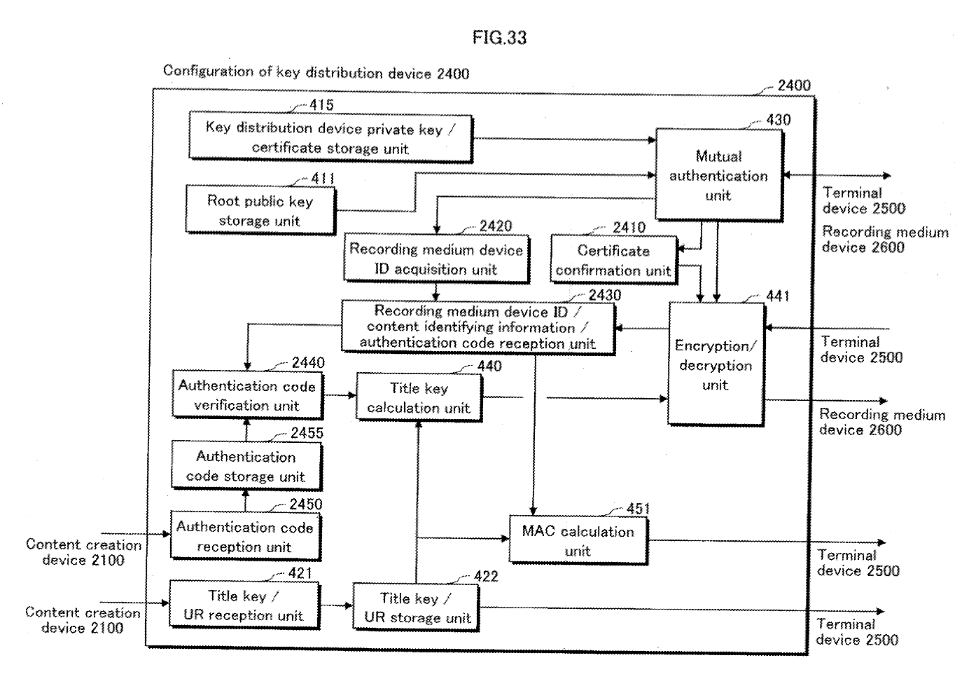

FIG. 33 shows the detailed configuration of the key distribution device 2400.

As shown in FIG. 33, the key distribution device 2400 includes a root public key storage unit 411, a key distribution device private key/certificate storage unit 415, a title key/UR reception unit 421, a title key/UR storage unit 422, a mutual authentication unit 430, a title key calculation unit 440, an encryption/decryption unit 441, a MAC calculation unit 451, a certificate confirmation unit 2410, a recording medium device ID acquisition unit 2420, a recording medium device ID/content identifying information/authentication code reception unit 2430, an authentication code verification unit 2440, an authentication code reception unit 2450, and an authentication code storage unit 2455.

The root public key storage unit 411 stores the root public key.

The key distribution device private key/certificate storage unit 415 stores a key pair of a key distribution device private key/certificate.

The title key/UR reception unit 421 receives the title key and the UR from the content creation device 2100.

The title key/UR storage unit 422 stores the title key and the UR received by the title key/UR reception unit 421. The title key/UR, storage unit 422 also transmits the stored UR to the terminal device 2500 in response to a request from the terminal device 2500.

The mutual authentication unit 430 performs mutual authentication with the terminal device 2500 or the recording medium device 2600 and shares a shared key with the terminal device 2500 or the recording medium device 2600. Note that mutual authentication has already been described with reference to FIG. 11.

The title key calculation unit 440 acquires the title key and the UR stored by the title key/UR storage unit 422, calculates a hash value of the UR, and generates a calculated title key by performing a simple, reversible calculation to combine operands, such as XOR, on the hash value and the title key. The title key calculation unit 440 then transmits the result to the recording medium device 2600 via the encryption/decryption unit 441.

The encryption/decryption unit 441 encrypts the calculated title key, generated by the title key calculation unit 440, with the shared key generated during the mutual authentication process by the mutual authentication unit 430. The encryption/decryption unit 441 transmits the result to the recording medium device 2600.

The MAC calculation unit 451 calculates a Message Authentication Code (MAC) using the title key stored by the title key/UR storage unit 422 and the recording medium device ID received by the recording medium device ID/content identifying information/authentication code reception unit 2430. The MAC calculation unit 451 transmits the result to the terminal device 2500.

The certificate confirmation unit 2410 acquires the certificate of the terminal device 2500 or the recording medium device 2600 received during mutual authentication by the mutual authentication unit 430, confirms the protocol whose performance is permitted for the terminal device 2500 or the recording medium device 2600, monitors the encryption/decryption unit 441, and suspends processing if an attempt is made to perform a non-permitted protocol.

The recording medium device ID acquisition unit 2420 confirms the content of the certificate of the recording medium device 2600 received during mutual authentication by the mutual authentication unit 430, acquires the recording medium device ID listed in the certificate, and notifies the recording medium device ID/content identifying information/authentication code reception unit 2430 of the recording medium device ID.

Via the encryption/decryption unit 441, the recording medium device ID/content identifying information/authentication code reception unit 2430 receives, from the terminal device 2500, the recording medium device ID of the recording medium device that is to be written to, the content identifying information, and the authentication code. Note that at the point at which the recording medium device ID has reached the key distribution device 2400, it is encrypted by the shared key. Therefore, before the recording medium device ID is transmitted to the recording medium device ID/content identifying information/authentication code reception unit 2430, the encryption/decryption unit 441 decrypts it with the shared key so that the recording medium device ID/content identifying information/authentication code reception unit 2430 can use the original recording medium device ID. Furthermore, it is confirmed whether the recording medium device ID matches the recording medium device ID received from the recording medium device ID acquisition unit 2420. If so, processing continues. Otherwise, processing is controlled, for example by suspending processing.

The authentication code verification unit 2440 confirms whether the authentication code received by the recording medium device ID/content identifying information/authentication code reception unit 2430 is stored in the authentication code storage unit 2455. If so, the authentication code verification unit 2440 confirms whether the number of copies permitted thus far is less than a pre-registered maximum number of copies. If both of these questions are confirmed, the authentication code verification unit 2440 permits processing by the title key calculation unit 440 for title key calculation and processing by the MAC calculation unit 451 for MAC calculation of the recording medium device ID. If either of these questions is not confirmed, the authentication code verification unit 2440 suspends processing such as title key calculation by the title key calculation unit 440 and MAC calculation of the recording medium device ID by the MAC calculation unit 451.

The authentication code reception unit 2450 receives the authentication code from the content creation device 2100.

The authentication code storage unit 2455 stores the authentication code received by the authentication code reception unit 2450. The authentication code may be bound with the content identifying information, the title key, the UR, and the like when stored by the authentication code storage unit 2455.

### Distribution Flow of Key Distribution Device 2400

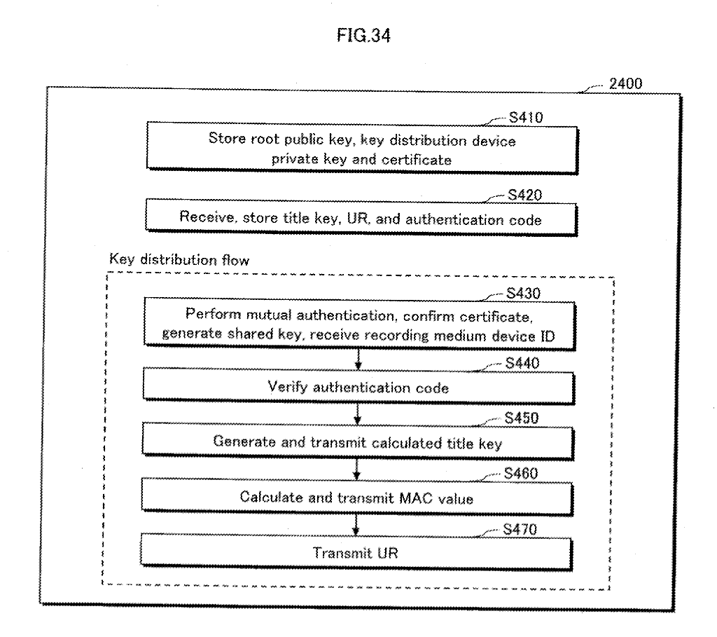

FIG. 34 shows the distribution flow of the key distribution device 2400.

The key distribution device 2400 stores a root public key and a key pair of a key distribution device private key/certificate (S410).

The key distribution device 2400 receives the title key, the UR, and the authentication code from the content creation device 2100 and stores these pieces of information. Note that it is preferable for these pieces of information to be registered as a set, and for the content identifying information to be included in the set (S420).

Upon receiving a request to transmit the title key from the terminal device 2500 or the recording medium device 2600, the key distribution device 2400 performs steps S430, S440, S450, S460, and S470.

The mutual authentication unit 430 performs mutual authentication with the terminal device 2500 or the recording medium device 2600 to confirm whether the terminal device 2500 or the recording medium device 2600 is trustable and to generate a shared key. Data is protected in subsequent communication by using the shared key to encrypt and decrypt the data.

The certificate confirmation unit 2410 analyzes the certificate acquired from the terminal device 2500 to confirm the protocol permitted for the terminal device 2500.

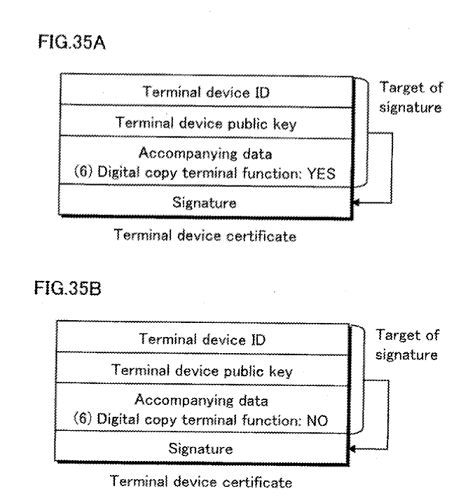

FIG. 35A is an example of a certificate for the case when processing related to digital copy is permitted for the terminal device 2500. If the certificate confirmation unit 2410 receives the certificate shown in FIG. 35A, the key distribution device 2400 permits processing to receive the recording medium device ID, content identifying information, and authentication code from the terminal device 2500, processing to notify the terminal device 2500 of the MAC calculation result, and processing to transmit the UR.

If the certificate confirmation unit 2410 receives the certificate shown in FIG. 35B, the key distribution device 2400 need not perform processing to receive the recording medium device ID, content identifying information, and authentication code from the terminal device 2500, processing to notify the terminal device 2500 of the MAC calculation result, and processing to transmit the UR to the terminal device 2500. Furthermore, the recording medium device ID/content identifying information/authentication code reception unit 2430 confirms whether the received recording medium device ID (2600) matches the recording medium device ID acquired by the recording medium device ID acquisition unit 2420. If the IDs do not match, subsequent processing may be suspended (S430).

The authentication code verification unit 2440 confirms whether the authentication code received by the recording medium device ID/content identifying information/authentication code reception unit 2430 matches the authentication code stored in the authentication code storage unit 2455. If so, the recording medium device ID/content identifying information/authentication code reception unit 2430 confirms whether the number of copies permitted thus far with the authentication code is less than a pre-registered maximum number of copies. If the authentication code matches the stored authentication code and the number of copies thus far is less than the pre-registered maximum number of copies, copying is permitted. The number of copies may be incremented (S440).

The title key calculation unit 440 acquires the title key and the UR stored by the title key/UR storage unit 422, calculates a hash value of the UR, and generates a calculated title key by performing a simple, reversible calculation to combine operands, such as XOR, on the hash value and the title key. The title key calculation unit 440 then transmits the result to the recording medium device 2600 via the encryption/decryption unit 441 (S450).

The MAC calculation unit 451 calculates a Message Authentication Code (MAC) using the recording medium device ID received by the recording medium device ID/content identifying information/authentication code reception unit 2430 and the title key stored by the title key/UR storage unit 422, transmitting the MAC value to the terminal device 2500 (S460).

The title key/UR storage unit 422 transmits the stored UR to the terminal device 2500 (S470).

### Detailed Configuration of Terminal Device 2500

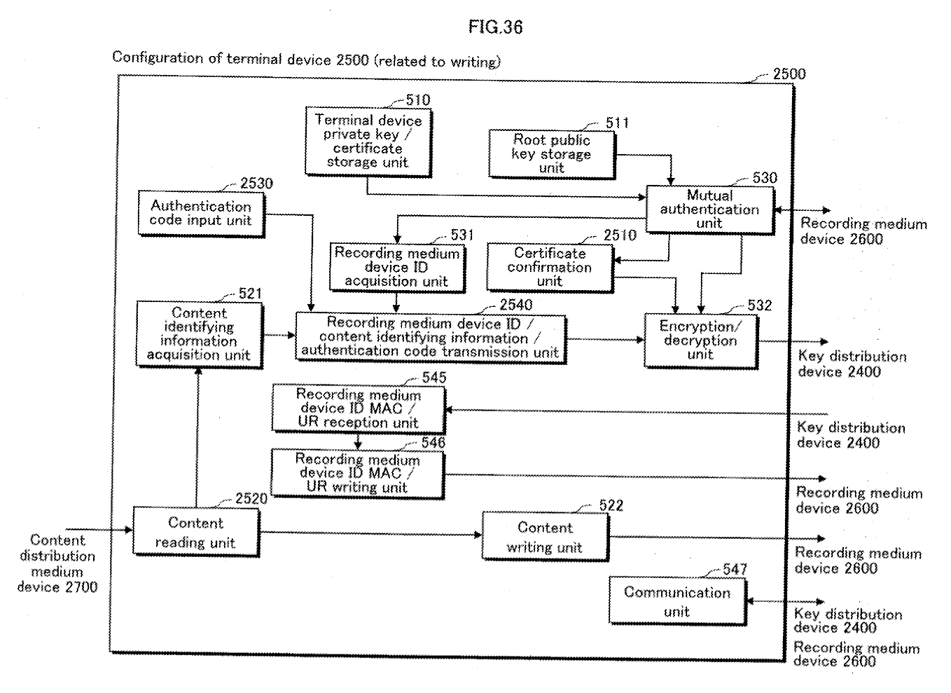

FIG. 36 shows the detailed configuration of the terminal device 2500. In particular, FIG. 36 shows the structure for the case in which the terminal device 2500 copies a content from the content distribution medium device 2700, acquires a key from the key distribution device 2400, and writes the content and the key on the recording medium device 2600.

As shown in FIG. 36, the terminal device 2500 includes a terminal device private key/certificate storage unit 510, a root public key storage unit 511, a content identifying information acquisition unit 521, a content writing unit 522, a mutual authentication unit 530, a recording medium device ID acquisition unit 531, an encryption/decryption unit 532, a recording medium device ED MAC/UR reception unit 545, a recording medium device ID MAC/UR writing unit 546, a communication unit 547, a certificate confirmation unit 2510, a content reading unit 2520, an authentication code input unit 2530, and a recording medium device ID/content identifying information/authentication code transmission unit 2540.

The terminal device private key/certificate storage unit 510 stores a key pair of the terminal device private key/terminal device certificate.

The root public key storage unit 511 stores the root public key.

If content identifying information that can uniquely identify the content, such as a hash table or hash value of the hash table, is embedded in the content received by the content reception unit 520, then the content identifying information acquisition unit 521 acquires the content identifying information.

The content writing unit 522 writes the content read by the content reading unit 2520 on the recording medium device 2600.

The mutual authentication unit 530 performs mutual authentication with the key distribution device 2400 or the recording medium device 2600 and shares a shared key with the key distribution device 2400 or the recording medium device 2600. Note that mutual authentication has already been described with reference to FIG. 11.

The recording medium device ID acquisition unit 531 analyzes the certificate of the recording medium device 2600, received during mutual authentication by the mutual authentication unit 530, to acquire the recording medium device ID.

The encryption/decryption unit 532 protects data over the communications channel during communication between the terminal device 2500 and the key distribution device 2400 or between the terminal device 2500 and the recording medium device 2600 by using the shared key shared by the mutual authentication unit 530 to encrypt data upon transmission and decrypt data upon reception.

The recording medium device ID/content identifying information/authentication code transmission unit 2540 treats the recording medium device ID acquired by the recording medium device ID acquisition unit 531 as the ID of the recording medium device to be written to and transmits this recording medium device ID as a set, along with the content identifying information acquired by the content identifying information acquisition unit 521 and the authentication code input into the authentication code input unit 2530, to the key distribution device 2400 via the encryption/decryption unit 532.

The recording medium device ID MAC/UR reception unit 545 receives the MAC value of the recording medium device ID from the key distribution device 2400 via the encryption/decryption unit 532, the MAC value representing a MAC calculation of the recording medium device ID, transmitted by the recording medium device ID/content identifying information/authentication code transmission unit 2540, the MAC calculation using the title key that protects the content identified by the content identifying information transmitted by the recording medium device ID/content identifying information/authentication code transmission unit 2540. The recording medium device ID MAC/UR reception unit 545 also receives, from the key distribution device 2400 without going through the encryption/decryption unit 532, the UR for the content identified by the content identifying information transmitted by the recording medium device ID/content identifying information/authentication code transmission unit 2540.

The recording medium device ID MAC/UR writing unit 546 writes the recording medium device ID MAC and the UR received by the recording medium device ID MAC/UR reception unit 545 on the recording medium device 2600.

The calculated title key reception unit 550 receives the calculated title key from the recording medium device 2600 via the encryption/decryption unit 532.

The communication unit 547 receives transmission data from the recording medium device 2600 and transmits data to the key distribution device 2400. The communication unit 547 also receives transmission data from the key distribution device 2400 and transmits data to the recording medium device 2600. Except for data related to control, such as a notification of termination of communication, the communication unit 547 supports communication between the key distribution device 2400 and the recording medium device 2600 without knowledge of the content of the communication data. During this communication between the key distribution device 2400 and the recording medium device 2600, the calculated title key data is protected while being conveyed.

The certificate confirmation unit 2510 acquires the certificate for the recording medium device 2600 received during mutual authentication by the mutual authentication unit 530, confirms the protocol whose performance is permitted for the recording medium device 2600, monitors the encryption/decryption unit 532, and suspends processing if an attempt is made to perform a non-permitted protocol.

The content reading unit 2520 reads the content from the content distribution medium device 2700.

The authentication code input unit 2530 accepts user input of an authentication code that is listed on a flyer inserted inside the package for the content distribution medium device 2700.

The recording medium device ID/content identifying information/authentication code transmission unit 2540 transmits the recording medium device ID acquired by the recording medium device ID acquisition unit 531, the authentication code input into the authentication code input unit 2530, and the content identifying information acquired by the content identifying information acquisition unit 521 to the key distribution device 2400 via the encryption/decryption unit 532.

### Processing Flow in Terminal Device 2500

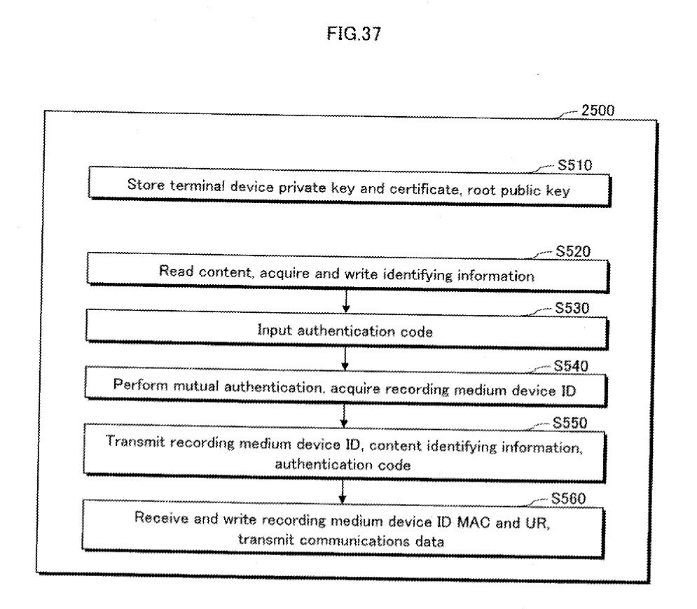

FIG. 37 shows the processing flow in the terminal device 2500.

S510 shows the manufacturing flow when manufacturing a terminal device.

The sequence of steps S520, S530, S540, S550, and S560 represent the processing flow for reading a content from the content distribution medium device 2700, acquiring information related to the key from the key distribution device 2400, and recording data on the recording medium device 2600.

The terminal device 2500 stores the terminal device private key/certificate and the root public key (S510).

The terminal device 2500 reads the content from the content distribution medium device 2700, analyzes the content, acquires the content identifying information, confirms that the content identifying information matches content identifying information that has been specified in advance, and writes the content on the recording medium device 2600 (S520).

The authentication code input unit 2530 accepts input of the authentication code (S530).

When the terminal device 2500 accesses the key distribution device 2400 or the recording medium device 2600, the mutual authentication unit 530 performs mutual authentication with the key distribution device 2400 or the recording medium device 2600 to confirm whether the key distribution device 2400 or the recording medium device 2600 is trustable and to generate a shared key. Data is protected in subsequent communication by using the shared key to encrypt and decrypt the data.

The certificate confirmation unit 2510 acquires the certificate of the key distribution device 2400 or the recording medium device 2600 received during mutual authentication by the mutual authentication unit 530, confirms the protocol whose performance is permitted for the key distribution device 2400 or the recording medium device 2600, monitors the encryption/decryption unit 532, and suspends processing if an attempt is made to perform a non-permitted protocol.

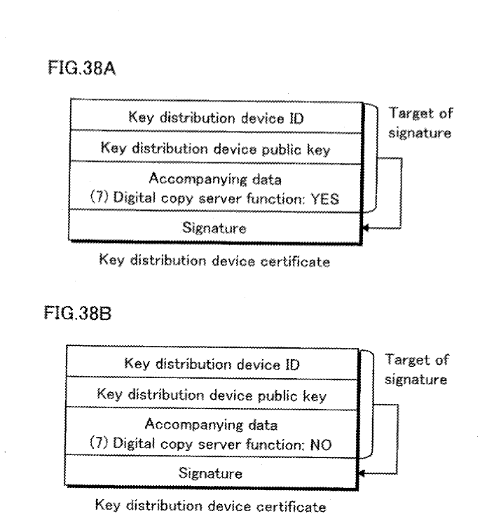

FIG. 38A is an example of a certificate for the case when a digital copy server function is permitted for the key distribution device 2400. If the certificate confirmation unit 2510 receives the certificate shown in FIG. 38A, the terminal device 2500 permits processing by the recording medium device ID/content identifying information/authentication code transmission unit 2540 to transmit the recording medium device ID, the content identifying information, and the authentication code. If the certificate confirmation unit 2410 receives the certificate shown in FIG. 38B, the terminal device 2500 need not perform processing by the recording medium device ID/content identifying information/authentication code transmission unit 2540 to transmit the recording medium device ID, the content identifying information, and the authentication code.

It is also determined whether the recording medium device ID of the recording medium device 2600, which is determined during the authentication by the mutual authentication unit 530, matches information listed in a revoke file distributed separately. If the recording medium device ID matches, the key distribution device 2400 or the recording medium device 2600 that is attempting to communicate is regarded as unauthorized. Communication and processing by the mutual authentication unit 530 may then be suspended. Note that in this step, the recording medium device ID acquisition unit 531 acquires the recording medium device ID (S540).

The terminal device 2500 transmits the recording medium device ID identified during mutual authentication, the content identifying information that identifies the content, and the authentication code input into the authentication code input unit 2530 to the key distribution device 2400 via the encryption/decryption unit 532 as a set (S550).

The terminal device 2500 receives, from the key distribution device 2400, the MAC value of the recording medium device ID and the UR. The terminal device 2500 writes the MAC value of the recording medium device ID and the UR on the recording medium device 2600. Furthermore, the terminal device 2500 conveys communications data between the key distribution device 2400 and the recording medium device 2600. The terminal device 2500 cannot become involved with the content of the communications data between the key distribution device 2400 and the recording medium device 2600; thus data is conveyed safely using the calculated title key (S560).

### Detailed Structure of Recording Medium Device 2600

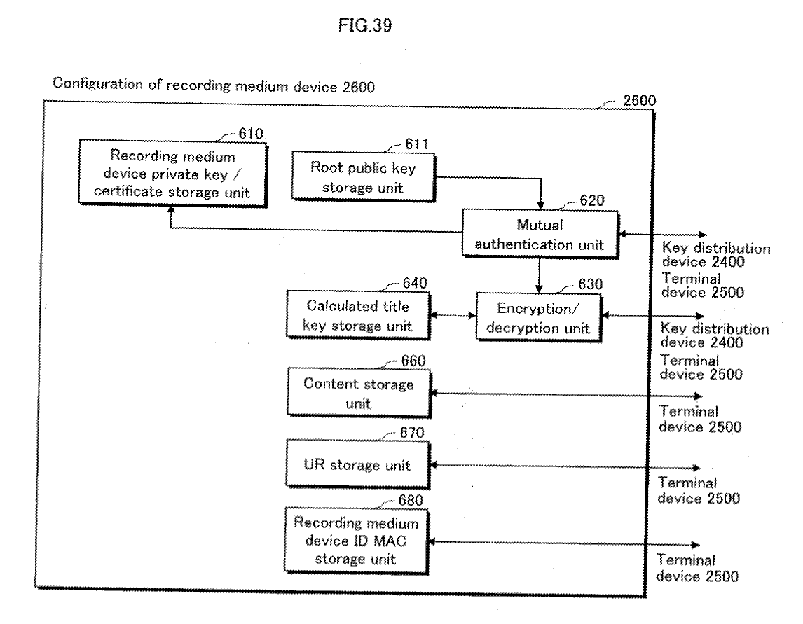

FIG. 39 shows the detailed configuration of the recording medium device 2600.

As shown in FIG. 39, the recording medium device 2600 includes a recording medium device private key/certificate storage unit 610, a root public key storage unit 611, a mutual authentication unit 620, an encryption/decryption unit 630, a calculated title key storage unit 640, a content storage unit 660, a UR storage unit 670, and a recording medium device ID MAC storage unit 680.

The recording medium device private key/certificate storage unit 610 stores the key pair of the recording medium device private key/recording medium device certificate.

The root public key storage unit 611 stores the root public key.

The mutual authentication unit 620 performs mutual authentication with the key distribution device 2400 or the terminal device 2500 and shares a shared key with the key distribution device 2400 or the terminal device 2500. Note that mutual authentication has already been described with reference to FIG. 11.

The encryption/decryption unit 630 protects data over the communications channel during communication between the recording medium device 2600 and the key distribution device 2400 or between the recording medium device 2600 and the terminal device 2500 by using the shared key shared by the mutual authentication unit 620 to encrypt data upon transmission and decrypt data upon reception.

The calculated title key storage unit 640 receives the calculated title key from the key distribution device 2400 and stores the received calculated title key. The calculated title key storage unit 640 also receives an acquisition request from the terminal device 2500 and transmits the calculated title key to the terminal device 2500.

The content storage unit 660 receives a content from the terminal device 2500 and stores the received content. The content storage unit 660 also receives a read request from the terminal device 2500 and transmits the content to the terminal device 2500.

The UR storage unit 670 receives a UR from the terminal device 2500 and stores the received UR. The UR storage unit 670 also receives a read request from the terminal device 2500 and transmits the UR to the terminal device 2500.

The recording medium device ID MAC storage unit 680 receives the recording medium device ID MAC from the terminal device 2500 and stores the received recording medium device ID MAC. The recording medium device ID MAC storage unit 680 also receives a read request from the terminal device 2500 and transmits the recording medium device ID MAC to the terminal device 2500.

### Processing Flow in Recording Medium Device 2600

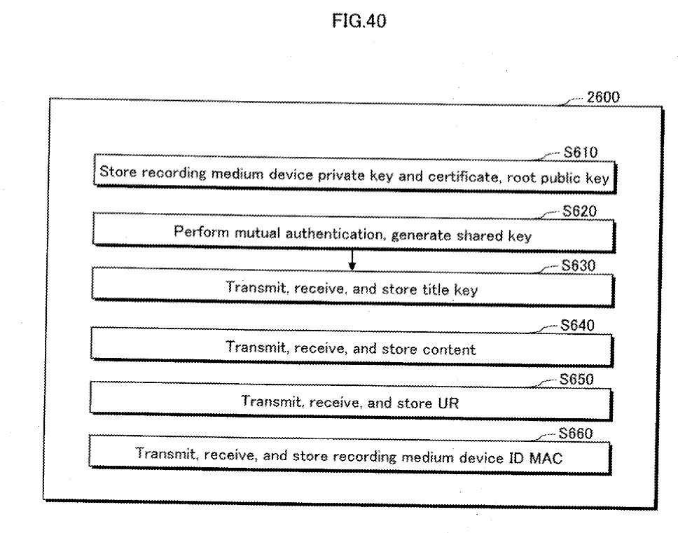

FIG. 40 shows the processing flow in the recording medium device 2600.

The recording medium device 2600 stores the recording medium device private key/certificate and the root public key (S610).

When the recording medium device 2600 is accessed by the key distribution device 2400 or the terminal device 2500, the mutual authentication unit 620 performs mutual authentication with the key distribution device 2400 or the terminal device 2500 to confirm whether the key distribution device 2400 or the terminal device 2500 is trustable and to generate a shared key. Data is protected in subsequent communication by using the shared key to encrypt and decrypt the data. It is also determined whether the terminal device ID of the terminal device 2500, or the key distribution device ID of the key distribution device 2400, which is determined during the authentication by the mutual authentication unit 620, matches information listed in a revoke file distributed separately. If the recording medium device ID or the key distribution device ID matches, the terminal device 2500 or the key distribution device 2400 that is attempting to communicate is regarded as unauthorized, and communication and processing by the mutual authentication unit 620 is suspended (S620).

The recording medium device 2600 receives the calculated title key from the key distribution device 2400 and stores the received calculated title key. The recording medium device 2600 also receives an acquisition request from the terminal device 2500 and transmits the calculated title key to the terminal device 2500 (S630).

The recording medium device 2600 receives a content from the terminal device 2500 and stores the received content. Upon receiving a read request, the recording medium device 2600 transmits the content to the terminal device 2500 (S640).

The recording medium device 2600 receives a UR from the terminal device 2500 and stores the received UR. Upon receiving a read request, the recording medium device 2600 transmits the UR to the terminal device 2500 (S650).

The recording medium device 2600 receives the MAC value of the recording medium device ID from the terminal device 2500 and stores the received MAC value. Upon receiving a read request, the recording medium device 2600 transmits the MAC value of the recording medium device ID to the terminal device 2500 (S660).

### Detailed Configuration of Content Distribution Medium Device 2700

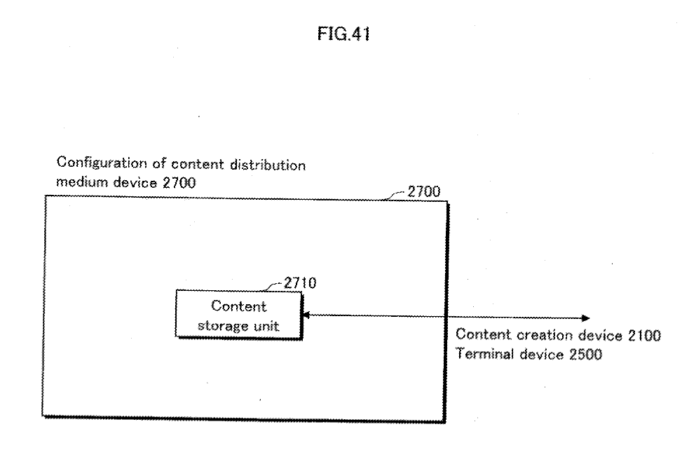

FIG. 41 shows the detailed configuration of the content distribution medium device 2700.

As shown in FIG. 41, the content distribution medium device 2700 includes a content storage unit 2710.

The content storage unit 2710 stores a content upon receiving an instruction from the content creation device 2100 to write content. The content storage unit 2710 also reads a content upon receiving an instruction from the terminal device 2500 to read content.

Configuration when Content Distribution Medium Device 2700 is Packaged

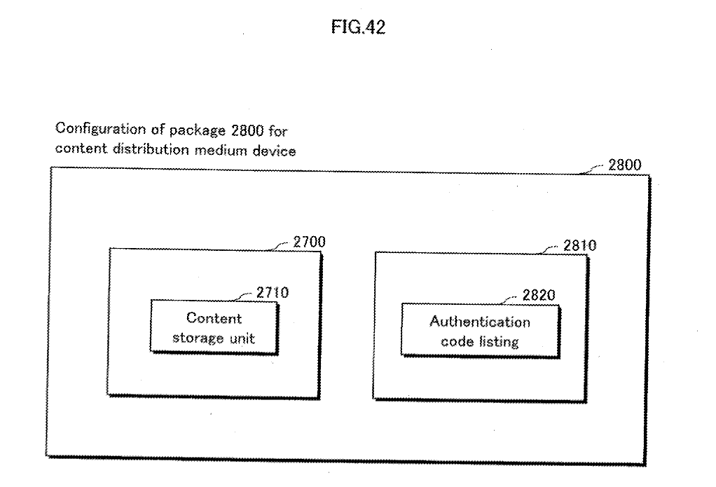

FIG. 42 shows an example of the configuration of a package for the content distribution medium device 2700.

The content distribution medium device 2700 and a flyer 2810 are included in the package 2800. An authentication code listing 2820 that includes the authentication code is printed on the flyer 2810.

### Variation on Content Distribution Medium Device 2700

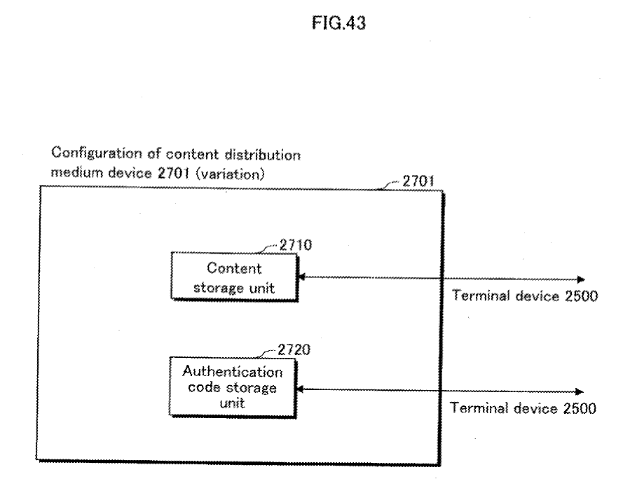

FIG. 43 shows a variation of the detailed configuration of the content distribution medium device 2700.

As shown in FIG. 43, the content distribution medium device 2700 includes a content storage unit 2710 and an authentication code storage unit 2720.

The content storage unit 2710 stores a content upon receiving an instruction from the content creation device 2100 to write content. The content storage unit 2710 also reads a content upon receiving an instruction from the terminal device 2500 to read content.

The authentication code storage unit 2720 stores an authentication code upon receiving an instruction from the content creation device 2100 to write the authentication code. The authentication code storage unit 2720 also reads the authentication code upon receiving an instruction from the terminal device 2500 to read the authentication code.

### Modifications

(1) In the above embodiments, the recording medium device is assumed to be a memory card such as an SD card, but the present invention is not limited in this way. A structure in which a storage device, such as a HDD, is combined with a control LSI is possible. Furthermore, the recording medium device need not be removable like a memory card, but may also be an internal memory device, such as in a cellular phone, eBook, or NetBook, combined with a control LSI.

(2) In the above embodiments, the mechanism for protecting data between the terminal device and the key distribution device, between the terminal device and the recording medium device, or between the key distribution device and the recording medium device has been described as protection with a shared key generated during mutual authentication, but protection is not limited in this way. Technology such as HTTPS may be used instead.

(3) In the above embodiments, the playback determination information is the MAC value of the identifying information for the recording medium device, but the playback determination information is not limited in this way. For example, the playback determination information may be the result of performing an XOR operation on the calculated title key and the identifying information for the recording medium device. The playback determination information may also be the result of performing an XOR operation on the calculated title key and a hash value of the identifying information for the recording medium device. Alternatively, the playback determination information may be the identifying information for the recording medium device to which the key issuing device attaches a signature, or to which the key distribution device attaches a signature. In this case, the terminal device may determine whether to permit playback by verifying the signature, for example with an XOR calculation.

### SUMMARY

In order to solve the above problem, a terminal device according to an aspect of the present invention performs functions in accordance with a supported function of a key distribution device.

Specifically, in accordance with whether the key distribution device supports a function to generate playback determination information, the terminal device determines whether to request generation of the playback determination information and whether to transmit data necessary for generation.

In accordance with whether the key distribution device supports a MOVE function, the terminal device determines whether to transmit a set of content identifying information and a recording medium device ID.

In accordance with whether the key distribution device supports a MOVE restoration function, the terminal device determines whether to transmit a set of content identifying information and a recording medium device ID of a transmitting recording medium device.

In accordance with whether the key distribution device supports digital copy processing, the terminal device determines whether to transmit a set of content identifying information for the content to be written, a recording medium device ID of the recording medium device to be written to, and an authentication code.

The content of these supported functions is listed in a certificate of the key distribution device. Furthermore, the certificate is signed with a root private key of the key issuing device, so that the authenticity of the supported functions can be verified with a root private key. Furthermore, the certificate can be verified by performing mutual authentication between the key distribution device and the terminal device to confirm correspondence with a private key held by the key distribution device.

The terminal device can transfer the title key in a concealed state by conveying data between the recording medium device to be written to and the key distribution device without directly handling the title key for cryptographic protection of the content.

In order to solve the above problem, a key distribution device according to an aspect of the present invention performs functions in accordance with a supported function of a terminal device.

Specifically, the key distribution device determines whether to generate and transmit playback determination information in accordance with whether the terminal device supports receipt of the playback determination information.

Note that the playback determination information may be the MAC value, calculated using the title key for cryptographic protection of the content, of the recording medium device ID. Alternatively, the playback determination information may be a signature generated for the recording medium device ID using the private key of the key distribution device, or other technology may be used to generate the playback determination information.

In accordance with whether the terminal device supports MOVE, the key distribution device determines whether to receive a set of a recording medium device ID indicating a transmitter, a recording medium device ID indicating a receiver, and content identifying information, and whether to generate and transmit playback determination information corresponding to the recording medium device ID indicating the receiver.

In accordance with whether the terminal device supports MOVE restoration processing, the key distribution device determines whether to receive a set of a recording medium device ID indicating a transmitter and content identifying information, whether to generate and transmit playback determination information corresponding to the recording medium device ID indicating the transmitter.

In accordance with whether the terminal device supports digital copy processing, the key distribution device determines whether to receive a set of a recording medium device ID of the recording medium device to be written to, content identifying information of the content to be written, and an authentication code, whether to accept the authentication code, whether to generate and transmit playback determination information corresponding to the recording medium device ID of the recording medium device to be written to.

Furthermore, the key distribution device analyzes transmission data received from the terminal device, confirms the receiver of the transmission data, and if the transmitter and the receiver of the transmission data are the same recording medium device, transmits the title key for cryptographic protection of the content by causing the terminal device to convey the title key to the recording medium device that is the receiver.

The terminal device can determine the supported function of the key distribution device. Therefore, even if an unauthorized key distribution device is provided with a pair of a key distribution device private key, acquired maliciously from a key distribution device, and a certificate including a public key, the terminal device can determine the supported function of the key distribution device and execute only limited functions, thereby limiting the scope of damage suffered by copyright owners and buyers.

Furthermore, the terminal device allows for a request to generate and transmit playback determination information to a legitimate key distribution device.

The terminal device allows for a request to perform MOVE processing on a legitimate key distribution device.

The terminal device allows for a request to perform MOVE restoration processing on a legitimate key distribution device.

The terminal device allows for a request to perform digital copy processing on a legitimate key distribution device.

The terminal device allows for acquisition of the certificate from the key distribution device and for verification of the certificate.

The terminal device allows for writing of the title key for cryptographic protection of the content on the recording medium device in a concealed state by not directly handling the title key when conveying data between the recording medium device to be written to and the key distribution device.

The key distribution device does not transmit the title key for cryptographic protection of the content directly to an unauthorized tool, even if the unauthorized tool stores a pair of a terminal device private key acquired maliciously from a legitimate terminal device and a certificate that includes a public key. Furthermore, by limiting the corresponding functions, the key distribution device limits the scope of damage.

The key distribution device can generate and transmit playback determination information to a legitimate terminal device.

The key distribution device can receive, from a legitimate terminal device, a set of the recording medium device ID indicating the transmitter, the recording medium device ID indicating the receiver, and content identifying information, and can generate and transmit playback determination information corresponding to the recording medium device ID indicating the receiver.

The key distribution device can receive, from a legitimate terminal device, a set of the recording medium device ID indicating the transmitter and content identifying information, and can generate and transmit playback determination information corresponding to the recording medium device ID indicating the transmitter.

The key distribution device can receive, from a legitimate terminal device, a set of a recording medium device ID of the recording medium device to be written to, content identifying information of the content to be written, and the authentication code, can accept the authentication code, and can generate and transmit playback determination information corresponding to the recording medium device ID of the recording medium device to be written to.

When not writing the title key on the recording medium device that is the receiver, the key distribution device can transmit the title key for cryptographic protection of the content to a different recording medium device.

### INDUSTRIAL APPLICABILITY

As operations for writing the title key are performed directly between the key distribution device and the recording medium device, the terminal device of the present invention is not directly involved in writing of the title key. Therefore, even when digital content is distributed electronically, it is possible to prevent a malicious act whereby an unauthorized tool, developed by malicious use of the key of a terminal device, poses as a legitimate terminal device and attempts to acquire the title key directly from the key distribution device.

### REFERENCE SIGNS LIST

100 content creation device
200 key issuing device
300 content distribution device
400 key distribution device
500 terminal device
600 recording medium device
1400 key distribution device
1500 terminal device
2100 content creation device
2400 key distribution device
2500 terminal device
2600 recording medium device
2700 content distribution medium device

1. A terminal device used in a content distribution system including a key distribution device, the terminal device, and a recording medium device, the key distribution device distributing a title key for protecting a content to the recording medium device, the terminal device for controlling writing of the title key on the recording medium device, and the recording medium device recording the content, wherein
the key distribution device and the recording medium device comprise a communication unit configured to transfer the title key safely between the key distribution device and the recording medium device without direct involvement by the terminal device, and
the terminal device confirms a supported function of the key distribution device and determines whether to permit operations pertaining to the key distribution device in accordance with the supported function.

2. The terminal device of claim 1, wherein
the supported function is listed in a certificate held by the key distribution device, and
the terminal device reliably confirms the supported function of the key distribution device by the certificate being securely transmitted from the key distribution device to the terminal device.

3. The terminal device of claim 2, wherein
the certificate of the key distribution device indicates whether the key distribution device supports generation of playback determination information, and
the terminal device determines whether to request generation of the playback determination information in accordance with whether the key distribution device supports generation of the playback determination information as indicated in the certificate.

4. The terminal device of claim 3, wherein
the playback determination information is a MAC value of a recording medium device ID calculated in accordance with the title key for cryptographic protection of the content.

5. The terminal device of claim 3, wherein
the playback determination information is a signature for a recording medium device ID, the signature generated with a private key of the key distribution device.

6. The terminal device of claim 2, wherein
the certificate of the key distribution device indicates whether the key distribution device supports MOVE processing, and
the terminal device determines whether to transmit a set of content identifying information and a recording medium device ID in accordance with whether the key distribution device supports the MOVE processing as indicated in the certificate.

7. The terminal device of claim 2, wherein
the certificate of the key distribution device indicates whether the key distribution device supports MOVE restoration processing, and
the terminal device determines whether to transmit a set of content identifying information and a recording medium device ID indicating a transmitting recording medium device in accordance with whether the key distribution device supports the MOVE restoration processing as indicated in the certificate.

8. The terminal device of claim 2, wherein
the certificate of the key distribution device indicates whether the key distribution device supports digital copy processing, and
the terminal device determines whether to transmit a set of content identifying information for the content to be written, a recording medium device ID of the recording medium device to be written to, and an authentication code in accordance with whether the key distribution device supports the digital copy processing as indicated in the certificate.

9. The terminal device of claim 1, wherein
the communication unit transfers the title key between the key distribution device and the recording medium device in a concealed state, so that the terminal device conveys data between the key distribution device and the recording medium device to be written to without directly handling the title key for cryptographic protection of the content.

10. A key distribution device used in a content distribution system including the key distribution device, a terminal device, and a recording medium device, the key distribution device distributing a title key for protecting a content to the recording medium device, the terminal device for controlling writing of the title key on the recording medium device, and the recording medium device recording the content, wherein
the terminal device notifies the key distribution device of a supported function of the terminal device, and
the key distribution device determines whether to permit operations pertaining to the terminal device in accordance with the supported function received from the terminal device.

11. The key distribution device of claim 10, wherein
the supported function is listed in a certificate held by the terminal device, and
the terminal device confirms the supported function of the terminal device by the certificate being transmitted from the terminal device to the key distribution device during mutual authentication.

12. The key distribution device of claim 11, wherein
the certificate of the terminal device indicates whether the terminal device supports reception and recording of playback determination information, and
the key distribution device generates and transmits the playback determination information in accordance with whether the terminal device supports reception and recording of the playback determination information as indicated in the certificate.

13. The key distribution device of claim 12, wherein
the playback determination information is a MAC value of a recording medium device ID calculated in accordance with the title key for cryptographic protection of the content.

14. The key distribution device of claim 12, wherein
the playback determination information is a signature for a recording medium device ID, the signature generated with a private key of the key distribution device.

15. The key distribution device of claim 11, wherein
the certificate of the terminal device indicates whether the terminal device supports MOVE processing, and
in accordance with whether the terminal device supports the MOVE processing as indicated in the certificate, the key distribution device stores a set of content identifying information, a recording medium device ID indicating a transmitting recording medium device, and a recording medium device ID indicating a receiving recording medium device, each recording medium device ID being received from the terminal device, generates the playback determination information in accordance with the recording medium device ID indicating the receiver, and transmits the playback determination information to the terminal device.

16. The key distribution device of claim 11, wherein
the certificate of the terminal device indicates whether the terminal device supports MOVE restoration processing, and
the key distribution device transmits a set of content identifying information and a recording medium device ID indicating a transmitting recording medium device in accordance with whether the terminal device supports the MOVE restoration processing as indicated in the certificate.

17. The key distribution device of claim 11, wherein
the certificate of the terminal device indicates whether the terminal device supports digital copy processing, and
in accordance with whether the terminal device supports the digital copy processing as indicated in the certificate, the key distribution device receives a set of content identifying information for the content that is to be written, a recording medium device ID of the recording medium device that is to be written to, and an authentication code, verifies the authentication code, generates the playback determination information in accordance with the recording medium device ID of the recording medium device that is to be written to, and transmits the playback determination information to the terminal device.

18. The key distribution device of claim 11, wherein
the key distribution device analyzes transmission data received from the terminal device to determine whether the transmission data belongs to a recording medium device that is to be written to, and when a transmitter of the transmission data is the same as the recording medium device that is to be written to, causes the terminal device to transmit the title key for cryptographic protection of the content to the recording medium device that is to be written to.
